(19) United States
(12) Patent Application Publication
(10) Pub. No.: US 2013/0152757 A1
(43) Pub. Date: Jun. 20, 2013

(54) VIBRATION CUTTING APPARATUS

(71) Applicants: Seiya Nakai, Chikushi-gun, Fukuoka (JP); Kazuhiro Noda, Chikushi-gun, Fukuoka (JP); Shoichi Heima, Kasuya-gun, Fukuoka (JP)

(72) Inventors: Seiya Nakai, Chikushi-gun, Fukuoka (JP); Kazuhiro Noda, Chikushi-gun, Fukuoka (JP); Shoichi Heima, Kasuya-gun, Fukuoka (JP)

(73) Assignees: PMT CORPORATION, Fukuoka (JP); ADWELDS CORPORATION, Fukuoka (JP)

(21) Appl. No.: 13/643,192

(22) PCT Filed: Apr. 26, 2011
(86) PCT No.: PCT/JP2011/002444

§ 371 Date: Mar. 4, 2013

(30) Foreign Application Priority Data
Apr. 27, 2010 (JP) 2010-102427
Oct. 21, 2010 (JP) 2010-236159
Apr. 22, 2011 (JP) 2011-095630

(51) Int. Cl. B26D 7/08

(52) U.S. Cl. CPC B26D 7/086
USPC 83/601

(57) ABSTRACT

Provided is a technique which can prevent abnormal vibrations from occurring on a resonator and apply, to a putting edge, vibrations with the magnitude of amplitude thereof adjusted in the direction of width of the edge, thereby cutting an object of interest with high accuracy. The resonator (21) with a grip portion grasped with clamp means (28) is supported by a support means (24), thereby preventing abnormal vibrations from occurring on the resonator (21). The resonator (21) has at least one elongated hole (26b) defined through a side thereof, thus allowing for adjusting the amplitude magnitude of vibrations in the direction of width of the cutting edge (23) on one end of the resonator (21). This enables vibrations with the amplitude of an adjusted magnitude in the direction of width to be applied to the cutting edge (23). Accordingly, the cutting edge (23) which is adequately vibrated can be used to cut the object of interest with high accuracy.

### TECHNICAL FIELD

The present invention relates to a technique for cutting an object with a flat-plate cutting blade by applying vibrations to the cutting blade formed with a cutting edge on a first end thereof.

### BACKGROUND ARTS

There has heretofore been known a technique for cutting the object with the flat-plate cutting blade by applying vibrations to the cutting blade formed with the cutting edge on the first end thereof (see, for example, Patent Document 1). Specifically, a resonator resonates with vibrations generated by an oscillator connected to a first end thereof and has the cutting blade mounted to a second end thereof. The object represented by a ceramic green sheet is placed on a stage and cut with the cutting blade subjected to the vibrations, By cutting the object in this manner, the cutting blade is prevented from suffering edge bending associated with the operation of cutting the object. Hence, cut pieces having better cut surfaces can be obtained as compared with a case where the vibrations are not applied to the cutting blade.

### PRIOR-ART DOCUMENT

### Patent Document

Patent Document 1: Japanese Unexamined Patent Publication No.1989-122408 (from page 3, upper-right column to page 3, lower-right column, FIG. 2, and the like).

### SUMMARY OF THE INVENTION

### Technical Problem

Recent years have seen continuing miniaturization of electronic devices which raised a demand for miniaturizing chip-type electronic components mounted on electronic devices. Specifically, there is a demand for forming a chip-type electronic component in dimensions of 1 mm×1 mm×1 mm or less. Patent Document 1 sets forth a cutting blade having an edge thickness of 200 μto 300 μm. In order to form the chip-type electronic components in dimensions conforming to the recent demands, however, the cutting blade must have the cutting edge formed thinner than 100 μm, or more desirably thinner than 50 μm. Further, a cutting object such as semiconductor wafer or ceramic green sheet laminate, or a material for forming the chip-type electronic component must be cut with higher precision by the cutting blade formed with the thin cutting edge as described above.

However, if the object is cut into a piece 1 mm×1 mm or less in size by the conventional technique using the cutting blade having the cutting edge thinner than that of the conventional cutting blade, the cut piece may suffer a defect such as flaw or crack caused by cutting the object. Furthermore, in a case where the cutting object is a ceramic green sheet laminate in which a predetermined wiring pattern is formed, a problem may occur that the wiring pattern formed in the laminate may be damaged because of displacement of cutting position. These problems may lead to decrease in the yield of products fabricated by cutting the object.

The inventors made various studies on potential causes of these problems to discover that the above problems are attributed to the following vibrational components applied to the cutting blade. The vibrational components oscillate in a different direction from that of natural vibrations of the oscillator which are parallel to the cutting blade. Specifically, the main body of the resonator undergoes microscopic lateral wobbling and the like irrespective of the natural vibrations of the oscillator because of a support structure of the resonator to be described hereinlater. Hence, the resonator is subjected to the vibrational components such as of the lateral wobbling in the different direction from that of the natural vibrations of the oscillator, or in other words, the vibrational components such as of the lateral wobbling in the different direction from that of the parallel vibrations to the cutting blade. If the vibrational components such as of the lateral wobbling in the different direction from that of the natural vibrations of the resonator (hereinafter, the vibrations such as the lateral wobbling that are irrespective of the vibrations of the oscillator will be referred to as “abnormal vibrations”) are applied by the resonator to the cutting blade, the cutting blade may sustain edge bending when cutting the object because the cutting blade is formed in a much smaller edge thickness than that of the conventional cutting blade. Further, the pieces cut from, the cutting object may suffer the flaws or cracks because of the lateral wobbling of the cutting edge of the cutting blade which results from the abnormal vibrations. In addition, the cutting edge with the laterally wobbling cutting blade forms an instable cutting angle to the object. When the wobbling cutting edge of the cutting blade is slightly displaced from a contact position for the cutting edge to make contact against the object, the cutting edge of the cutting blade may be bent by cutting into the object at an angle. In this case, the displacement of the cutting edge from the contact position between the cutting edge and the object is minimal. However, a significant misalignment occurs in the cut surface of the object cut by the cutting blade so that the wiring pattern formed in the laminate body as the cutting object may be damaged.

The present inventors identified the causative factor of the abnormal vibrations of the resonator, which is explained as below. In the conventional practice, the resonator is supported by support means via any of various elastic vibration absorbing materials in order to allow the resonator to perform stable vibrations without disturbance at a predetermined frequency. According to an example shown in FIG. 27, for instance, an outer periphery of a resonator 500 is integrally formed with a flange 501 at a position equivalent to a point of minimum oscillation amplitude (nodal point) of the resonator 500. The flange 501 is clamped by support means 503 via O-rings 502 formed of an elastic member such as rubber whereby the resonator 500 is supported by the support means 503.

According to an example shown in FIG. 28, an outer periphery of a resonator 600 is integrally formed with a diaphragm structure 601 at a position corresponding to a nodal point of the resonator 600. The diaphragm structure 601 is clamped by support means 602 whereby the resonator 600 is supported by the support means 602. According to an example shown in FIG. 29, a resonator 700 is formed of a plurality of horns 700a and boosters 700b which are interconnected by means of headless screws. A diaphragm 702 is fitted in a gap at a connection position 701 between the horns 700a and the boosters 700b. The connection position is equivalent to a point of maximum oscillation of the resonator 700. An outside circumference of the diaphragm 702 is clamped by support means 703 whereby the resonator 700 is supported by the support means 703.

In this manner, the resonators are supported by the support means via a variety of vibration absorbing materials (the O-ring 502, diaphragm structure 601, diaphragm 702). Hence, the resonators are not rigidly supported. This makes it impossible to prevent the resonators from being subjected to the abnormal vibrations such as lateral wobbling. Although the magnitude of the abnormal vibrations occurring in the resonator is minimal, the magnitude of the above abnormal vibrations is significant in the case of a cutting process performed with positional precision of 1 mm or less, for example. Cutting the object with the cutting blade affected by the abnormal vibrations such as the lateral wobbling may result in the above-described problems. FIG. 27 to FIG. 29 each illustrate an example of the conventional method for supporting the resonator. FIG. 27, FIG. 28 and FIG. 29A are partly sectional views. FIG. 29B is a front view showing the diaphragm 702.

In the case where the cutting blade is screwed to the resonator, the screws cannot rigidly fix the cutting blade onto the resonator. When the vibrations are applied by the resonator, the cutting blade undergoes lateral micro-wobbling. The magnitude of the lateral wobbling of the cutting blade is minimal. However, in a case where the cutting blade is required to cut the object with positional precision of 1 mm or less, the magnitude of the lateral wobbling of the cutting blade is unignorable. The lateral wobbling of the cutting blade may result in unignorable size variations of cut pieces or unignorable degrees of displacement of cut position. According to the conventional techniques described above, the cutting blade is integrally bonded to the resonator with a brazing material or solder, thereby preventing the problem that the vibrations from the resonator bring the cutting blade into the lateral wobbling.

FIG. 30 shows an exemplary vibrational mode of the conventional resonator. In a case where a resonator 800 has a first end connected with an oscillator 801 and a second end to which a cutting blade 802 is bonded in a manner that a cutting edge of the cutting blade 802 is perpendicular to a vibration direction of the oscillator 801 indicated by an arrowed line 803, a distribution of vibration amplitudes across the width of the second end of the resonator 800 (a transverse direction of the drawing surface of FIG. 22) is substantially in the form of low convex in which the amplitude is the largest at the center of the second end and decreased toward the opposite ends thereof, as indicated by a solid line 804. In the width direction of the cutting blade 802, therefore, the vibrations at the center and at the opposite ends of the cutting blade 802 have different amplitudes. Hence, stresses at a bonding area between the cutting blade 802 and the resonator 800 significantly vary between a central portion and the opposite ends of the bonding area in the width direction.

In this manner, the bonding area between the cutting-blade 802 and the resonator 800 is subjected to the stresses significantly varied in magnitude between the central portion and the opposite ends of the bonding area in the width direction. This may result in partial breakage of the brazing material or solder bonding the cutting blade 802 to the resonator 800 or, at worst, result in separation of the cutting blade 802 from the resonator 800.

Heretofore, any consideration has not been given to the inclinations of the cutting edge of the cutting blade and the top surface of the stage. In the conventional practice, the object on the top surface is cut with the cutting blade, the cutting edge of which is inclined at a different angle from that of the top surface of the stage. When cutting the object, therefore, the cutting edge of the cutting blade cats in the object by amounts varying across the width of the cutting edge. In order to ensure that even a part of the cutting edge that cuts less into the object can reliably cut the object, the cutting blade must be unduly pressed into the object during the cutting operation. The increased cut-in amount (the increased press-in amount) of the cutting blade into the object has entailed a significant wear of the cutting blade.

Conventionally, a clearance groove allowing for retreat of the cutting edge is formed in the top surface of the stage such that after cutting the object, the cutting edge of the cutting blade may not be damaged by contact against the top surface of the stage carrying the object thereon. Such a clearance groove is configured to hast a larger width than the thickness of the cutting blade. More recently, however, the following problem has arisen in conjunction with the great reduction in thickness of the cutting object. Because of frictional force generated between the cut surface and the cutting blade by cutting the object, a cut end of the object is pressed down in a pressing direction of the cutting blade and into the clearance groove. This results in a demand for technical improvement.

In view of the above problems, the invention has an object to provide a technique that prevents the occurrence of the abnormal vibrations in the resonator and permits the cutting blade to cut the object precisely by applying to the cutting blade the vibrations adjusted in the magnitude of amplitude across the width of the cutting blade.

### Solution to Problem

According to a first aspect of the invention for solving the above problem, a vibration cutting apparatus for cutting an object with a cutting blade by applying: vibrations to the cutting blade, comprises: a resonator connected to an oscillator at a first end thereof and mounted with the cutting blade at a mounting portion defined by a second end thereof opposite to the oscillator; and support means that includes a grasping portion for grasping a grip portion of the resonator and supports the resonator, and is characterized in that the resonator has at least one elongated hole cut through a lateral side thereof (Claim 1).

According the invention featuring such a structure, the resonator has the grip portion to be grasped by the grasping portion thereby supported by the support means. Unlike in the case of a conventional practice, the support means supports the resonator by way of the grasping portion rigidly grasping the resonator without interposing the elastic vibration absorbing member between the support means and the resonator. Thus, the resonator is prevented from being subjected to the abnormal vibrations, such as the lateral wobbling, oscillating in the different direction from that of the natural vibrations of the oscillator connected to the first end of the resonator.

The present inventors observed the vibrational modes of the resonator resonating with the oscillator and repeatedly performed a variety of experiments on the vibrational modes of the resonator. Finally, the inventors found that the vibrations at individual areas of the resonator can be adjusted in the direction and the magnitude of amplitude by cutting the elongated hole through the resonator. Focusing attention on this finding, the inventors designed a structure in which the cutting blade is mounted to the mounting portion of the resonator and at least, one elongated hole is cut through the lateral side of the resonator. In this structure, the magnitude of amplitude of the vibrations across the width of the cutting blade on the second end of the resonator can be adjusted by the elongated hole cut through the resonator. The vibrations adjusted in the magnitude of amplitude across the width of the cutting blade can be applied to the cutting blade. Thus, the cutting blade subjected to the appropriately conditioned vibrations is adapted to cut the object with high precisions. In this case, it is preferred to fixedly secure the cutting blade to the mounting portion of the resonator with a brazing metal or solder.

The inventors made various studies on a technique that prevents the disturbance of the vibrations of the resonator even if the resonator is rigidly grasped by the grasping portion without interposing the elastic vibration absorbing member between the resonator and the grasping portion. In the conventional practice, the elastic vibration absorbing member is interposed between the resonator and the grasping portion. In other words, the inventors studied on the technique for rigidly supporting the resonator without changing the natural frequency of the resonator. As a result, the inventors found that a material having a great logarithmic decrement or a material having a great sound propagation speed is suitable for forming the grasping portion to grasp the resonator. Specifically, the material having the great logarithmic decrement is less prone to transmit vibrations, quickly absorbing the abnormal vibrations in the different direction from that of the natural vibrations of the resonator. It is believed, that the grasping portion of the support means that is formed of the material having a logarithmic decrement of more than 0.01 and less than 1 can effectively suppress the abnormal vibrations of the resonator and can support the resonator without disturbing the vibrations of the resonator. The material having the great sound propagation speed has such a high vibration transmission speed as to dissipate the abnormal vibrations of the resonator quickly. It is believed that the grasping portion of the support means that is formed of the material having a sound propagation speed of more than 5900 m/s can effectively suppress the abnormal vibrations of the resonator and can support the resonator without disturbing the vibrations of the resonator.

It is therefore desirable that the grasping portion of the support means that grasps the grip portion of the resonator is formed of the material having a logarithmic decrement of more than 0.01 and less than 1. In this way, the grasping portion is adapted to absorb the above-described abnormal vibrations quickly at the contact area, between the resonator and the support means. The resonator is allowed to undergo stable vibrations in a desired vibrational mode while the abnormal vibrations are appropriately absorbed by the grasping portion. Hence, the vibrations can be properly applied to the cutting blade. The position where the grip portion of the resonator is formed is not limited to the nodal point of the resonator but may be any place on the resonator. Since the grip portion may be formed at any place on the resonator, it is easy to make, modification to the structure of an apparatus equipped with the support means for supporting the resonator. Furthermore, the support means can be reduced in the size or the number because unlike in the case of the conventional practice, the support means is adapted to support the resonator without interposing the vibration absorbing member between the support means and the resonator. It is therefore easy to downsize or simplify the apparatus.

The grasping portion of the support means that grasps the grip portion of the resonator may also be formed of the material having a sound propagation speed of more than 5900 m/s. In this way, the grasping portion is also adapted for quick transmission of the abnormal vibrations at the contact area between the resonator and the support means. The resonator is allowed to undergo the stable vibrations in the desired vibrational mode while the abnormal vibrations are appropriately dissipated by the grasping portion. Hence, the vibrations can be properly applied to the cutting blade. The position where the grip portion of the resonator is formed is not limited to the nodal point of the resonator but may be at any place on the resonator. Since the grip portion may be formed at any place on the resonator, it is easy to make modification to the structure of the apparatus equipped with the support means for supporting the resonator. Furthermore, the support means can be reduced in the size or the number because unlike in the case of the conventional practice, the support means is adapted to support the resonator without interposing the vibration absorbing member between the support means and the resonator. It is therefore easy to downsize or simplify the apparatus.

The inventors also made various studies on the configuration of the grip portion of the resonator such that the resonator may be supported by the support means without being disturbed in the vibration thereof. As a result, the inventors found that the support means supporting the resonator at position closer to the nodal point on the center axis of the resonator in the vibration direction thereof is effective in supporting the resonator without disturbing the vibrations of the resonator.

It is therefore preferred that a recessed groove is formed in an outer periphery of the resonator at place corresponding to the nodal point on the center axis of the resonator in the vibration direction thereof and that the recessed groove as the grip portion is grasped by the grasping portion. Such a configuration permits the grasping portion to grasp the resonator at the position closer to the nodal point. This obviates the problem that the vibration of the resonator is disturbed by the support means that supports the resonator by grasping the grip portion of the resonator.

Since the object is cut by the cutting blade being subjected to the vibrations, the object undergoes less cutting resistance when cut by the cutting blade. This permits the cutting blade to apply less pressure force onto the object to cut the object.

Since the object is cut by the cutting blade subjected to the vibrations, the cutting edge is susceptible to less adhesion of cut debris derived from the object. The cutting edge is prevented from suffering a built-up edge formed of the cut debris from the object.

The resonator vibrates by being repeatedly expanded and contracted based on Poisson's ratio. In a case where the cutting blade is mounted to the resonator by means of a conventional split clamp with screws, for example, the vibrations of the resonator cannot be faithfully transmitted to the cutting blade. In the above-described structure, however, the cutting blade is secured to the resonator with the brazing metal or solder so that the vibrations of the resonator can be transmitted to the cutting blade faithfully.

In this case, as suggested in a second aspect of the invention (Claim 2), it is preferred that the mounting portion includes a mating groove formed at the second end of the resonator, and that the cutting blade is shaped like a rectangular flat plate having a cutting edge on a first end thereof and is mounted to the mounting portion of the resonator by fittably inserting a second end thereof opposite to the cutting edge and bonding opposite lateral sides of the second end to the mating groove on the overall width.

According to a third aspect of the Invention, it is preferred that the opposite lateral sides of the second end of the cutting blade or the opposite inside surfaces of the mating groove are formed with recessed grooves across the width thereof (Claim 3).

In such a structure, a brazing metal, solder or an adhesive agent such as a thermosetting adhesive is filled in the recessed grooves formed in the opposite lateral sides of the second end of the cutting blade or in the opposite inside surfaces of the mating groove across the width thereof when the cutting blade is bonded to the mating groove of the resonator. Therefore, the cutting blade can be assuredly bended to the mating groove formed in the resonator.

According to a fourth aspect of the invention, it is preferred that the mounting portion includes a step portion having an L-shaped cross section and formed by partially cutting away an end surface of the second end of the resonator, and that the cutting blade is secured to a mounting surface of the step portion, the mounting surface extending in parallel to the vibration direction of the resonator (Claim 4).

Such a structure is advantageous in that the cutting blade only need be bonded to the mounting surface with the brazing metal, solder or adhesive agent, namely the cutting blade can be readily secured, to the resonator without the need, of fitting the cutting blade in the groove. If the mounting surface is in the form of a flat surface or curved surface, the cutting blade is bonded in conformity to the flat surface or curved surface. This means that the object can be cut. into any of various configurations by selecting such a mounting surface that conforms to a desired, configuration into which the object, to be cut.

According to a fifth aspect of the invention, it is also preferred that the mounting portion includes; a step portion having an L-shaped cross section and formed by partially cutting away an end surface of the second end of the resonator; and a mounting base for clamping the cutting blade between the mounting base, and a mounting surface of the step portion, the mounting surface extending in parallel to the vibration direction of the resonator, and that the cutting blade is shaped like a flat plate having the cutting edge on a first end thereof, and is mounted to the mounting portion by securing the cutting blade exclusive of the cutting edge to the mounting base, and fixing the cutting blade together with the mounting base to the mounting surface with bolts (Claim 5).

Such a structure permits the cutting blade to toe mere assuredly counted to the resonator because the butting blade exclusive of the cutting edge is secured to the mean ting base so that the mounting base together with the cutting blade can be fixed to the mounting surface with the belts. Incidentally, an adhesive agent or bracing metal, may be used for securing the cutting blade to the mounting base.

Recording to a sixth aspect of the invention, it is also preferred that the mounting portion includes a flat-plate mounting base, a first side of which is mounted with the cutting blade and a second side of which is fixed to the second, end of the resonator (Claim 6).

In, such a structure, the cutting blade can be readily mounted to the resonator by fixing the second side of the flat-plate mounting base to the second end of the resonator, the mounting base baring the cutting blade fixed to the first side thereof.

according to a seventh aspect of the invention, it is also preferred that the cutting blade is format integrally with the mounting base (Claim 7).

In such a structure, the cutting blade is formed integrally with the mounting base thereby being rigidly fixed to the mounting base. This makes the cutting blade less susceptible to the abnormal vibrations associated with the ultrasonic vibrations of the resonator and hence, the cutting apparatus can achieve improved cutting precisions.

According to an eighth aspect of the invention, it is also preferred that a plurality of the mounting bases are carried on a sheet-like member and any one of the mounting bases on the sheet-like member is made to stick fast to the second end of the resonator (Claim 8).

In such a structure, any one of the plural mounting bases carried on the sheet-like member is made to stick, fast to the second end of the resonator, so that the cutting blade can be readily mounted to the resonator. In a case where the cutting blade of the mounting base made to stick fast to the resonator is damaged by wear or the like, the cutting blade mounted to the resonator can be readily replaced by causing another mounting base together with a new cutting blade to stick fast to the second end of the resonator.

According to a ninth aspect of the invention, it is also preferred that the cutting blade has a pointed tip on the cutting edge thereof (Claim 9). Such a structure permits the cutting blade to cut the object into a complicated configuration by cutting while moving the object relative to the cutting blade.

According to a tenth aspect of the invention, it is also preferred that the elongated hole is parallel to a vibration direction of the oscillator (Claim 10).

Such a structure provides for the adjustment of amplitude of the vibrations at individual areas on either side of the elongated hole of the resonator.

According to an eleventh aspect of the invention, it is also preferred that the elongated, hole is inclined relative to the vibration direction of the oscillator (Claim 11).

Such a structure is adapted to convert vibrations substantially perpendicular to the cutting edge of the cutting blade to vibrations containing vibrational components substantially parallel to the cutting edge of the cutting blade. The vibrations substantially perpendicular to the cutting edge of the cutting blade are at an area adjoining the first end of the resonator that is connected with the oscillator while the vibrations containing the vibrational components substantially parallel to the cutting edge are at an area adjoining the second end of the resonator, namely the area across the elongated hole from the area adjoining the first end of the resonator. Thus, the vibrational components substantially parallel to the cutting edge are added to the vibrations applied to the cutting blade by the resonator, so that the cutting blade is made to vibrate in vertical and transverse directions in a manner to trace an arc. The object is cut by the cutting blade moved like a kitchen knife, for example, which is used in a manner combining draw cut and push cut. Therefore, the cutting blade is capable of cutting the object with superior cutting performance or with higher precision.

According to a twelfth aspect of the invention, it is preferred that the vibration cutting apparatus further comprises a stage that includes a top surface on which the object is placed, and a copying mechanism for adjusting the inclination of the top surface; moving means for moving the resonator toward or away from the stage, the resonator supported by the support means in a manner to direct the cutting edge toward the stage; and control means for controlling the copying mechanism and the moving means, and is characterized in that the control, means operates the moving means to bring the cutting edge into contact against the top surface by moving the resonator to the stage, and operates the copying mechanism to match the inclination of the cutting edge with that of the top surface (Claim 12).

In such a structure, the vibration cutting apparatus further includes: the stage that includes the top surface on which the object is placed, and the copying mechanism for adjusting the inclination of the top surface; the moving means that moves the resonator toward or away from the stage, the resonator supported by the support means in a manner to direct the cutting edge toward the stage; and the control means that controls the copying mechanism and the moving means. The control means provides control such that the moving means brings the cutting edge into contact against the top surface by moving the resonator to the stage and that the copying mechanism matches the inclination of the cutting edge with that of the top surface. Hence, the cutting blade is adapted to cut the object with the cutting edge inclined at substantially the same angle as that of the top surface.

When cutting the object, therefore, the cutting blade cuts in the object by substantially an equal amount across the width of the cutting edge. This permits the cutting blade to be pressed into the object by the minimum necessary amount for cutting the object and thence, the wear of the cutting blade can be suppressed. In the case of meeting a recent demand for cutting an object having a thickness of less than 1 mm, for example, the cutting blade is adapted to cut the object by being pressed into the object by the minimum amount. The cutting blade can cut the object more precisely than in the conventional practice where the cutting blade is pressed into the object more than necessary.

According to a thirteenth aspect of the invention, it is preferred that the control means operates the moving means to move the resonator to the stage in a manner to allow the cutting blade to apply a constant pressure force of a predetermined value to the object (Claim 13).

The present inventors made various studies on the cause of edge bending of the cutting blade cutting the object and found that a speed at which the cutting blade is pressed into the object and a pressure force, applied onto the object by the cutting blade are key factors involved in the edge bending. If the control means controls the press-in speed of the cutting blade into the object to such a speed as to provide a degree of edge bending within allowance limits of cutting precision required of the cutting blade, the press-in speed of the cutting blade into the object may be lowered more than necessary. This may result in reduced efficiency of the cutting work on the object. Hence, the control means operates the moving means to move the resonator toward the stage in a manner to allow the cutting blade to apply a constant pressure force of a predetermined value to the object to thereby limit the edge bending within the allowance limits of the required cutting precision. By controlling the pressure force in this manner, the press-in speed of the cutting blade into the object is automatically regulated. Hence, the cutting edge of the cutting blade is pressed in the object at the highest possible speed that provides the degree of edge bending within the allowance limits of the cutting precision. Thus is achieved an increased efficiency of cutting work on the object while controlling the degree of edge bending within the allowance limits of the cutting precision.

According to a fourteenth aspect of the invention, it is also preferred that the vibration cutting apparatus further comprises a stage including a buffer layer provided with a top surface on which the object is placed, and is characterized in that the buffer layer is formed of a material permitting the cutting blade to cut in (Claim 14).

In such a structure, the buffer layer is formed of the material that allows the cutting blade to cut in and hence, the buffer layer can prevent the breakage of the cutting blade even if the cutting edge of the cutting blade is brought into contact against the top surface during the operation of cutting the object. When the cutting blade cutting the object forms a notch in the top surface of the buffer layer on which the object is placed, the resultant notch functions as a clearance groove allowing for the smooth retreat of the cutting blade. Further, the notch formed by the cutting blade has substantially the same thickness as that, of the cutting blade. Therefore, the notch is adapted to prevent the cutting blade from pushing cut ends of the object into the notch during cutting of the object. The cutting blade can cut out pieces from the object into a shape with high precisions. Even if the cutting operation encounters misalignment between the notch formed in the top surface and the cutting edge of the cutting blade, the breakage of the cutting blade can be prevented because the buffer layer is formed of the material that allows the cutting blade to cut therein.

### Advantageous Effects of Invention

According to the first aspect of the invention, the resonator is supported by the support means, the grasping port ion of which grasps the grip portion of the resonator. Unlike in the case of the conventional practice, the support means supports the resonator without interposing the elastic vibration absorbing member between the support means and the resonator, thereby preventing the resonator from suffering the occurrence of abnormal vibrations in the different direction from that of the natural, vibrations of the oscillator connected to the first end of the resonator.

Since the cutting blade is mounted to the mounting portion of the resonator and at least one elongated hole is cut through the lateral side of the resonator, the vibrations across the width of the cutting blade at the second end of the resonator are adjusted in the magnitude of amplitude. Thus, the vibrations adjusted in the magnitude of amplitude across the width can be applied to the cutting blade. Accordingly, the cutting apparatus can cut the object precisely with the cutting blade subjected to the appropriately conditioned vibrations.

According to the second aspect of the invention, the cutting apparatus can precisely cut the object with the cutting blade subjected to the appropriately conditioned vibrations, similarly to the first aspect hereof.

According to the third aspect of the invention, the brazing metal, solder or adhesive agent such as thermosetting adhesive is filled in the recessed grooves formed in the opposite lateral sides of the second end of the cutting blade or in the opposite inside surfaces of the mating groove across the width thereof when the cutting blade is bonded to the mating groove of the resonator. This ensures that the cutting blade is reliably bonded to the mating groove formed at the resonator.

According to the fourth aspect of the invention, the cutting blade only need be secured to the mounting surface with the brazing metal, solder or the adhesive agent. The cutting blade can be readily secured, to the resonator without the need of fitting the cutting blade in the groove. If the mounting surface is in the form of a flat surface or curved surface, the cutting blade is bonded in conformity to the flat surface or curved surface. This means that the object can be cut into any of various configurations by selecting such a mounting surface that conforms to a desired configuration into which the object to be cut.

According to the fifth aspect, of the invention, the cutting blade except for the cutting edge is secured to the mounting base and the mounting base together with the cutting blade is fixed to the mounting surface with the bolts. Hence, the cutting blade can be more reliably mounted to the resonator.

According to the sixth aspect of the invention, the cutting blade can be readily mounted to the resonator by mounting the flat-plate mounting base to the resonator. The flat-plate mounting base has the first side mounted with the cutting blade and the second side secured to the second end of the resonator.

According to the seventh aspect of the invention, the cutting blade is formed integrally with the mounting base so that the cutting blade is more rigidly mounted to the mounting base. The cutting blade is made less susceptible to the abnormal vibrations associated with the ultrasonic vibrations of the resonator, thus achieving increased cutting precision.

According to the eighth aspect of the invention, any one of the plural mounting bases carried on the sheet-like member is made to stick fast to the second end of the resonator, so that the cutting blade can be readily mounted to the resonator. In a case where the cutting blade of the mounting base made to stick fast to the resonator is damaged by wear or the like, the cutting blade fixed to the resonator can be readily replaced by causing another mounting base together with a new cutting blade to stick fast to the second end of the resonator.

According to the ninth aspect of the invention, the cutting blade is adapted to cut the object into a complicated configuration by cutting while moving the object relative to the cutting blade.

According to the tenth aspect of the invention, the vibrations of the resonator at the individual areas on either side of the elongated hole can be adjusted in the amplitude.

According to the eleventh aspect of the invention, the vibrations substantially perpendicular to the cutting edge of the cutting blade can be converted to the vibrations containing vibrational components substantially parallel to the cutting edge of the cutting blade. The vibrations substantially perpendicular to the cutting edge of the cutting blade are at the area adjoining the first end of the resonator connected with the oscillator while the vibrations containing the vibrational components substantially parallel to the cutting edge are at the area adjoining the second end of the resonator, namely the area across the elongated hole from the area adjoining the first, end of the resonator. Thus, the vibrational components substantially parallel to the cutting edge are added to the vibrations applied by the resonator to the cutting blade, so as to make the cutting blade vibrate in vertical and transverse directions in a manner to trace an arc. The object is cut by the cutting blade moved like a kitchen knife, for example, which is used in a manner combining draw cut and push cut. Therefore, the cutting blade is capable of cutting the object with superior cutting performance or with higher precision.

According to the twelfth aspect of the invention, the cutting blade is capable of cutting the object with the cutting edge having the inclination substantially matched with that of the top surface. When cutting the object, therefore, the cutting blade cuts in the object by substantially an equal amount across the width of the cutting edge, This permits the cutting blade to be pressed into the object by the minimum necessary amount for cutting the object and thence, the wear of the cutting blade can be suppressed.

According to the thirteenth aspect of the invention, the moving means moves the resonator to the stage in a manner to allow the cutting blade to apply the constant pressure force of the predetermined value to the object such as to provide the degree of edge bending within the allowance limits of the required cutting precision. By controlling the pressure force in this manner, the press-in speed of the cutting blade into the object is automatically regulated. Hence, the cutting edge of the cutting blade is pressed in the object, at the highest possible speed that provides the degree of edge bending within the allowance limits of the cutting precision, Thus is achieved an increased efficiency of cutting work on the object while controlling the degree of edge bending within the allowance limits of the cutting precision.

According to the fourteenth aspect of the invention, the buffer layer is formed of the material that allows the cutting blade: to cut in and hence, the buffer layer can prevent the breakage of the gutting blade even if the cutting, edge of the cutting blade is brought irate contact against the top surface during cutting of the object. When the cutting blade cutting the object forms a notch in the top surface of the buffer layer on which the object is placed, the resultant notch functions as a clearance groove allowing for the smooth retreat of the cutting blade. Further, the notch formed by the cutting blade has substantially the same thickness as that of the cutting blade. Therefore, the notch is adapted to prevent the cutting blade from pushing cut end of the object into the notch during cutting of the object. The cutting blade can cut out pieces from the object into a shape with high precisions.

### BRIEF DESCRIPTION OF DRAWINGS

FIG. 1 is a diagram, showing a vibration cutting apparatus according to a first embodiment of the invention.

FIG. 2 is an enlarged view showing an essential part of FIG. 1;

FIG. 3 is a diagram showing a resonator of FIG. 1;

FIG. 4 is a group of enlarged views showing a horn constituting the resonator;

FIG. 5 is a group of diagrams showing how the resonator shown in FIG. 3 is supported by support means;

FIG. 6 is a flow chart showing the steps of an exemplary operation of the apparatus of FIG. 1;

FIG. 7 is a group of diagrams showing a first exemplary modification of the resonator;

FIG. 8 is a group of diagrams showing a second exemplary modification of the resonator;

FIG. 9 is a group of diagrams showing a first exemplary modification of a cutting blade;

FIG. 10 is a diagram showing a resonator according to a second embodiment of the vibration cutting apparatus of the invention;

FIG. 11 is a group of enlarged views showing an essential part according to a third embodiment of the vibration cutting apparatus of the invention;

FIG. 12 is a diagram showing a fourth embodiment of the vibration cutting apparatus of the invention;

FIG. 13 is a diagram showing a resonator according to a fifth, embodiment of the vibration cutting apparatus of the invention;

FIG. 14 is a group of diagrams showing a second exemplary modification of the cutting blade;

FIG. 15 is a group of diagrams showing a resonator according to a sixth embodiment of the vibration cutting apparatus of the invention;

FIG. 16 is a group of diagrams showing a third exemplary modification of the resonator;

FIG. 17 is a diagram showing a resonator according to a seventh embodiment of the vibration cutting apparatus of the invention;

FIG. 18 is an enlarged view showing an essential part according to an eighth embodiment of the vibration cutting apparatus of the invention;

FIG. 19 is a group of enlarged views showing an essential part according to a ninth embodiment of the vibration cutting apparatus of the invention;

FIG. 20 is a group of diagrams showing a fourth exemplary modification of the resonator;

FIG. 21 is a group of diagrams showing a fifth exemplary modification of the resonator;

FIG. 22 is a group of diagrams showing a sixth exemplary modification of the resonator;

FIG. 23 is a group of diagrams showing a seventh exemplary modification of the resonator;

FIG. 24 is a diagram showing another exemplary method of retaining mounting bases according to the seventh exemplary modification of the resonator;

FIG. 25 is a group of enlarged views showing an essential part, according to a tenth embodiment of the vibration cutting apparatus of the invention;

FIG. 26 is a group of diagrams snowing a resonator according to an eleventh embodiment of the vibration cutting apparatus of the invention;

FIG. 27 is a diagram showing an exemplary conventional method of supporting the resonator;

FIG. 28 is a diagram showing an exemplary conventional method of supporting the resonator;

FIG. 29 is a group of diagrams showing an exemplary conventional method of supporting the resonator; and

FIG. 30 is a diagram showing an exemplary vibrational mode of a conventional resonator.

### DESCRIPTION OF EMBODIMENT

### First Embodiment

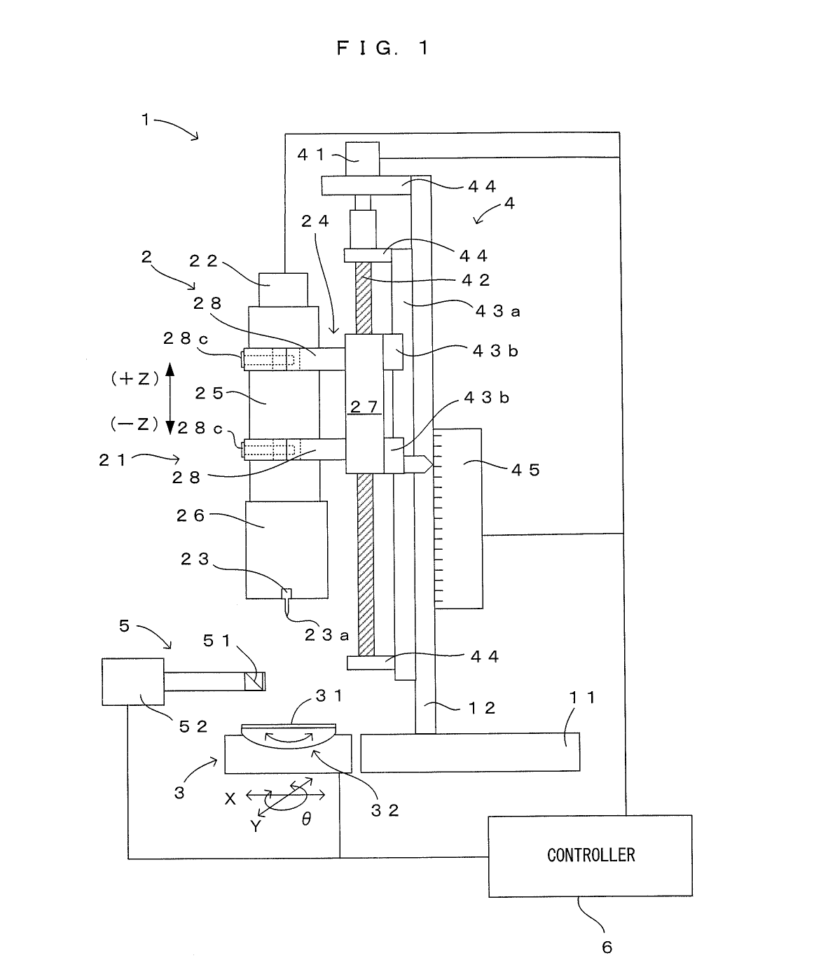

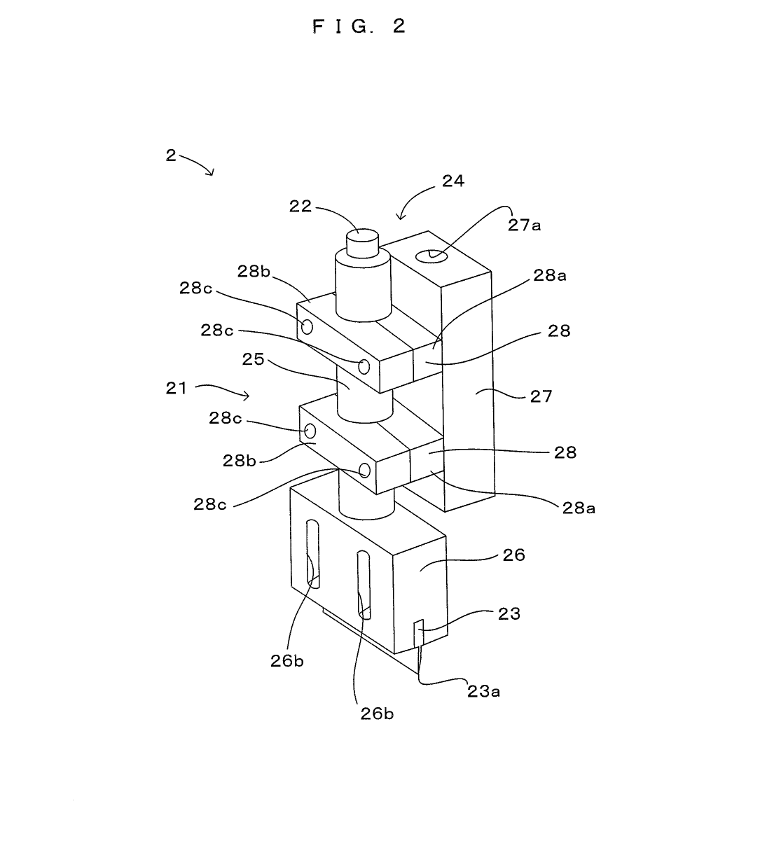

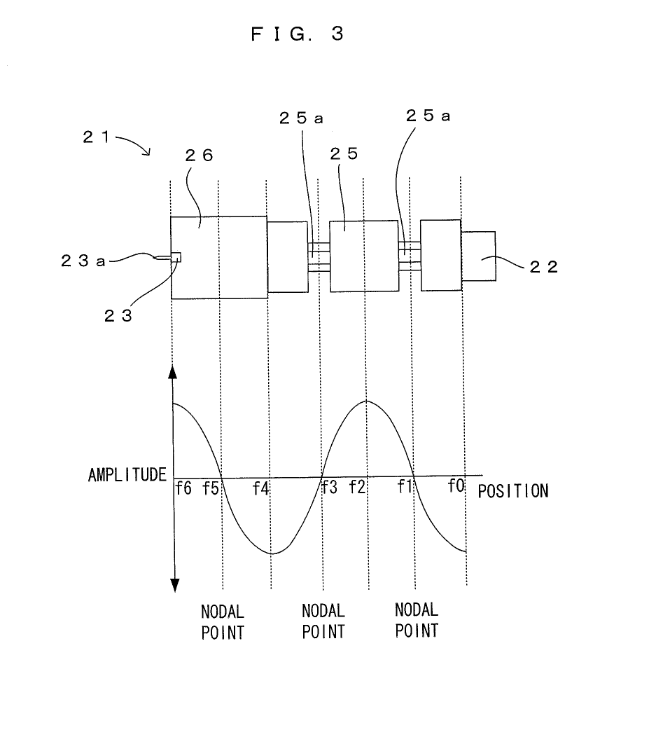

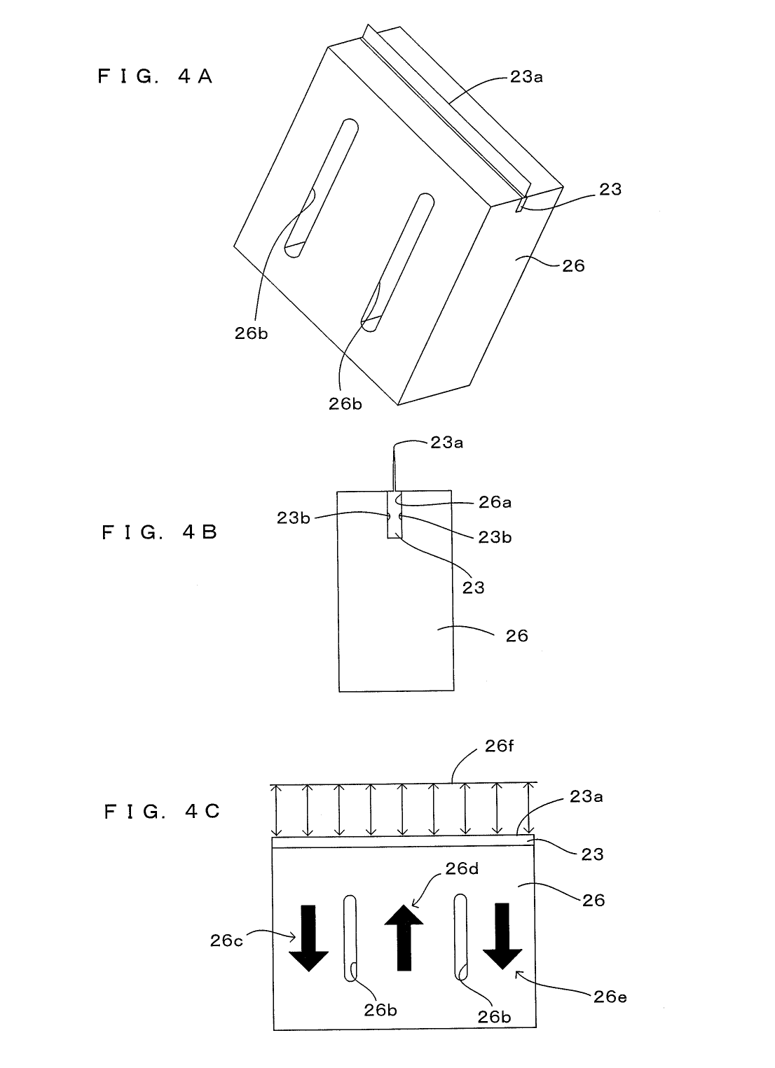

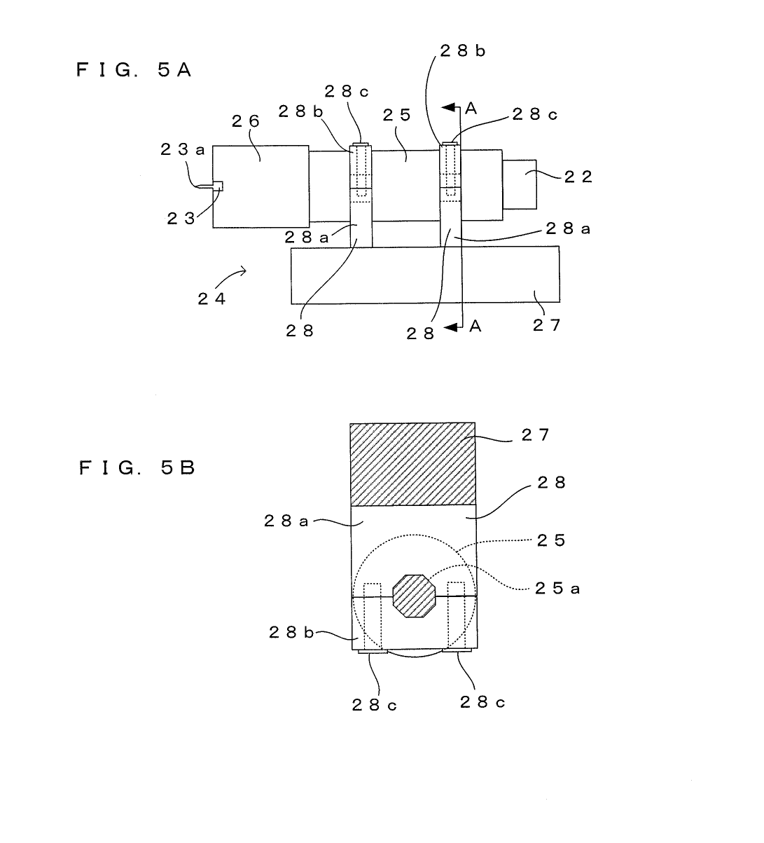

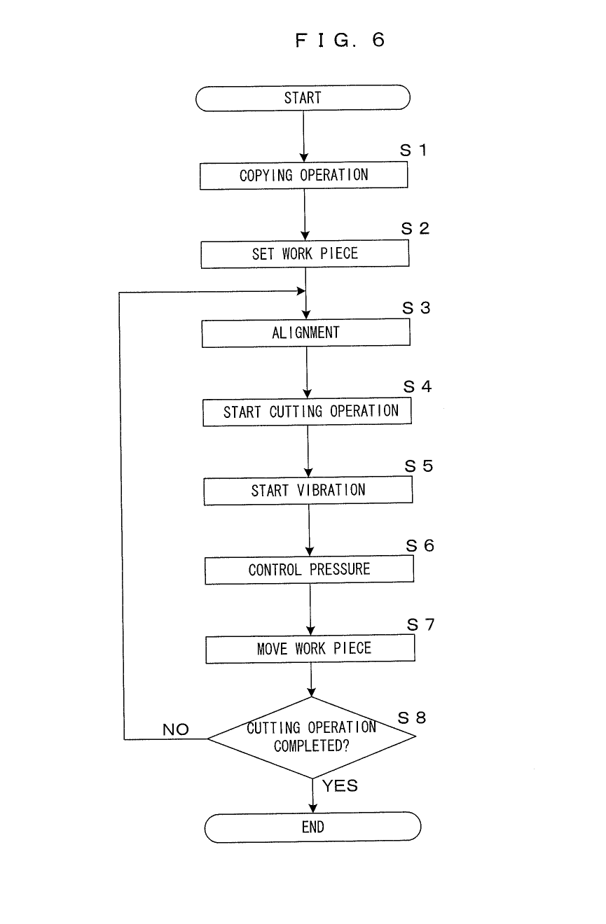

a vibration cutting apparatus according to a first embodiment of the invention is described with reference to FIG. 1 to FIG. 6, FIG. 1 is an elevation of a vibration cutting apparatus 1 according to a first embodiment of the invention as viewed from the side thereof. FIG. 2 is an enlarged perspective view showing an essential part of FIG. 1. FIG. 3 is a diagram showing a resonator 21 of FIG. 1. FIG. 4 is a group of enlarged views showing a horn 26 in an upside-down position, the horn constituting the resonator 21. FIG. 4A is a perspective view of the horn. FIG. 4B is a side view of the horn and FIG. 4C is a front view thereof. FIG. 5 is a group of diagrams showing the resonator 21 of FIG. 3 supported in a horizontal position by support means 24. FIG. 5A is a side view of the resonator and FIG. 5B is a sectional view taken on the arrowed line A-A in FIG. 5A. FIG. 6 is a flow chart showing the steps of an exemplary operation of the apparatus of FIG. 1.

### (Structure of Apparatus)

The vibration cutting apparatus 1 shown in FIG. 1 cuts a cutting object on a top surface 31 of a stage 3 with a flat-plate cutting blade 23 by applying vibrations to the cutting blade. The cutting blade is formed with a cutting edge 23a on a first end thereof. The vibration cutting apparatus 1 includes: a head portion 2 provided with the resonator 21; the stage 3 carrying the cutting object on the top surface 31 thereof; a drive mechanism 4 (equivalent to “moving means” of the invention) for drivably moving up and down the resonator 21 supported by the support means 24; position recognition means 5 for recognizing relative position between the object carried on the top surface 31 of the stage 3 and the cutting edge 23a of the cutting blade 23 mounted to the. resonator 21; and a controller 5 for controlling the individual components of the vibration cutting apparatus 1.

As shown in FIG. 2, the head portion 2 includes: the resonator 21 having a first end connected to an oscillator 22 and a second end which is opposite to the oscillator 22 and mounted with the cutting blade 23; and the support means 24 for supporting the resonator 21. Under the control of the controller 6, the oscillator 22 produces ultrasonic vibrations. Resonating with the ultrasonic vibrations, the resonator 21 applies to the gutting blade 23 the ultrasonic vibrations oscillating in a direction of the center axis of the resonator 21. A detailed description oh the structure and operations of the head portion 2 will be made hereinlater.

The stage 3 includes: the top surface 31 that carries thereon the out ting object such as ceramic green sheet laminate, semiconductor wafer, circuit board, laminate substrate formed of synthetic resin, metal, sheet, silicon, ferrite, quartz, glass, ceramic, resin board, single-layer thin metal film, and thin metal film laminate; and a copying mechanism 32 for adjusting the inclination of the top surface 31. The stage 3 includes a transfer axis that permits X-Y translation and θ-rotation transfer thereof. The stage 3 is designed to adjust, under the control of the controller 6, relative position between the cutting edge 23a of the cutting blade 23 mounted to the resonator 21 and the object placed on the top surface 31.

The top surface 31 is provided with a retaining mechanism (not shown) for retaining the object to be cut. The retaining mechanism may have any structure such as based on a vacuum suction mechanism or mechanical chuck function so long as the structure is adapted to retain the object on the top surface 31. Alternatively, the stage may dispense with the retaining mechanism and be simply designed to allow the object to be placed on the top surface 31.

According to this embodiment, the copying mechanism 32 is designed to bring the inclination of the top surface 31 into conformity with the inclination of a copy object by utilizing a moment produced by pressing the copy object against the top surface 31 of the stage 3. Under the control of the controller 6, the copying mechanism 32 is capable of maintaining the position of the top surface 31 being inclined at a predetermined. angle. In a state, for example, where the cutting edge 23a of the cutting blade 23 mounted to the resonator 21 is pressed against the top surface 31 so that the top surface 31 is inclined in conformity with the inclination of the cutting edge 23a, the copying mechanism 32 is controlled by the controller 6 so as to keep the top surface 31 inclined at the angle conforming with the inclination of cutting edge 23a.

The copying mechanism 32 is not limited to the above structure but may adopt any structure that is based on a general copying mechanism adapted to maintain the top surface 31 in the predetermined inclination. For example, a copying mechanism may be constructed such that a piezoelectric device also functioning as pressure detecting means is used to form a piezoelectric, actuator and that the piezoelectric actuators are disposed at least at three places under the top surface 31. The controller 6 permits the copying mechanism to adjust the inclination of the top surface 31 by driving the piezoelectric actuators in a manner to equalize pressures detected by the individual piezoelectric actuators. The copying mechanism, may rely on the actuators to adjust the inclination of the top surface 31.

The drive mechanism 4 moves the resonator 21 to and away from the stage 3. The resonator 21 is supported by the support means 24 in a manner that the cutting edge 23a of the cutting blade 23 mounted to the resonator 21 is oriented to the top surface 31 of the stage 3. The drive mechanism 4 includes a driving motor 41 and a ball screw 42. A support post 12 upstands from a support structure 11 and has a guide 43a connected thereto. The drive mechanism 4 is connected to the support post 12 and the guide 43a via a frame 44.

The driving motor 41 rotates under the control of the controller 6 thereby moving up and down the support means 24 threadably mounted on the ball screw 42 while slidably moving a guide 43b on the guide 43a. The guide 43b is attached to the support means 24. Thus, the resonator 21 supported by the support means 24 is moved to the stage 3 or away from the stage 3.

The drive mechanism 4 is designed to regulate the drive torque of the driving motor 41 under the control of the controller 6 so as to press the resonator 21 supported by the support means 24 against the stage 3 with a predetermined pressure force.

The support post 12 is provided with a linear encoder 45 that detects a height of the head portion 2. The controller 6 controls the driving motor 41 based on a detection signal from the linear encoder 45, so that the height of the head portion 2 can be adjusted.

The position recognition means 5 includes a dual field-of-view optical lens 51, a camera 52 formed of imaging means such as CCD or CMOS, and a driver portion (not shown) for moving the dual field-of-view optical lens 51 in horizontal and vertical directions. The position recognition means 5 operates the driver portion to insert the dual field-of-view optical lens 51 in space between the object on the top surface 31 and the cutting edge 23a of the cutting blade 23 in opposed relation with the top surface, so as to recognize an alignment mark provided on the object for position recognition and the cutting edge 23a. It is noted that the structure of the position recognition means 5 is not limited, to this but may have any structure that permits the recognition of the relative position between the object on the top surface 31 and the cutting edge 23a which are arranged in opposed relation.

The controller 6 is equipped with an operation panel (not shown) through which the general control of the vibration cutting apparatus is provided. The controller 6 controls the magnitude of ultrasonic energy calculated from the value of voltage or current applied to the oscillator 22; controllably switches the copying mechanism 32 of the stage 3 between an enabled state of free movement and a disabled state of free movement; controls the driving motor 41 based on the detection signal from the linear encoder 45; controls the driving toque of the driving motor 41 and the movement of the position recognition means 5; and controls the stage 3 in movement in the horizontal direction and rotational direction based on the defection signal from the position recognition means 5. By doing so, the controller 6 adjusts the height of the head portion 2 in the direction of an arrowed line Z in FIG. 1 or the relative position between the cutting edge 23a of the cutting blade 23 and the object on the top surface 31.

### (Structure of Head Portion)

Next, description is made on the resonator 21 and support means 24 that belong to the head portion: 2,

As shown in FIG. 2 and FIG. 3, the resonator 21 includes a booster 2 5 and the horn 26. A second end of the booster 25 is connected to a first end of the horn 26 by means of headless screws in a manner that the canter axes of the booster and the horn align, with each other.

As shown in FIG. 3, the booster 25 is termed in the wavelength of one cycle of the resonant wave such that a substantial central position f2 of the booster 25 may coincide with a point of maximum oscillation amplitude and that opposite end positions f0 and f4 of the booster may coincide with the points of maximum oscillation amplitude. In this case, positions f1 and f3 a quarter wave away from the points of maximum oscillation correspond to first and second points of minimum oscillation amplitude, respectively. The booster 25 is formed in a cylindrical column shape which has a circular cross section as seen from the position f4. The oscillator 22 is connected to a first end of the booster 25, that defines the position f0, by means of headless screws in a manner that the center axes of the booster and the oscillator align with each other.

As shown in FIG. 3, recessed grooves are formed in an outer periphery of the booster 25 at the position f1 as the first point of minimum oscillation amplitude and the position f3 as the second point of minimum oscillation amplitude, thereby defining respective grip portions 25a at which the booster 25 (resonator 21) is grasped. In this embodiment, as shown in FIG. 5B, the grasp portion 25a is so formed as to have an octagonal cross section taken on the line substantially perpendicular to the center axis of the booster 25. However, the grasp portion 25a may also be formed to have a cross section shaped like a circle or any other polygon.

As shown in FIG. 3, the horn 26 is formed in the wavelength of one-half cycle of the resonant wave such that opposite end positions f4 and f6 of the horn may coincide with the points of maximum oscillation amplitude. In this case, a substantial central position f5 of the horn 26 coincides with a third point of minimum, oscillation amplitude. As shown in FIG. 4A, the horn 26 is formed in a rectangular parallelepiped. As shown in FIG. 4B, the horn 26 is formed with a mating groove 26a at a mounting portion of a second end thereof. The flat-plate cutting blade 23 has recessed grooves 23b formed in opposite lateral, sides of a second end thereof opposite to the first end where the cutting edge 23a is formed. The recessed groove 23b extends across the width of the cutting blade. The cutting blade 23 is filled in the mating groove 26a from the second end thereof and the opposite lateral sides of the second end are bonded to the mating groove 26a on the overall, width length thereof. In this manner, the cutting blade 23 is mounted to the horn 26.

The horn 26 further includes two elongated holes 26b cut through a lateral side thereof. The elongated holes 26b extend substantially in parallel to the direction of center axis of the booster 25 and horn 26, namely in a vibration direction of the oscillator 22.

In the resonator 21 having this structure, the oscillator 22 generates the ultrasonic vibrations under the control of the controller 6. Hence, the resonator 21 is brought into the vibrations in the direction of center axis. At this time, as indicated by thick arrows in FIG. 4C, the vibrations at individual areas 26c to 26e on either side of the elongated holes 26b are adjusted in phase and amplitude because this embodiment is constructed such that the horn 26 has the two elongated holes 26b cut therethrough and extended substantially in parallel to the vibration direction. As indicated by the solid line 26f in FIG. 4C, therefore, the amplitude of the vibrations is substantially equalized across the width of the second end of the horn 26 so that the vibrations adjusted in the magnitude of amplitude across the width can be applied to the cutting blade 23.

The cutting blade 23 may be formed of various materials such as high carbon steel, carbon tool steel, alloy tool steel, high-speed steel, sintered high-speed steel, cemented carbide, ceramics, cermet, and industrial diamond. The cutting blade is so formed as to have an edge thickness in the range of several micrometers to about 200 μm depending on the type of cutting object or the required size of cut piece. The cutting blade 23 is bonded to the resonator 7 with a resin adhesive having thermosetting property or thermoplastic property, a brazing metal such as Ni, Cu and Ag, solder or the like. Further, the cutting edge 23a of the cutting blade 23 may be coated with a hard material such as titanium nitride, titanium carbonitride, titanium aluminum nitride or aluminum chromium nitride by chemical vapor deposition (CVD) or physical vapor deposition (PVD).

As shown in FIG. 5, the support means 2 4 includes a base portion 27 and clamp means 28 (equivalent to “grasping portion” of the invention). The support means 24 supports the resonator 21 by grasping the grip portions 25a of the booster 25 with the clamp means 28.

As shown in FIG. 2, the base portion 27 is formed with a screw hole 27a for threadable engagement with the ball screw 42 of the drive mechanism 4.

The clamp means 28 is disposed at two places on the base portion 27 so as to be able to grasp the two grip portions 25a formed at the booster 25. Each clamp means 28 includes a first member 28a and a second member 28b. As shown in FIG. 5B, the first member 28a and the second member 28b are each formed with a recess conforming to a cross sectional shape of the grip portion 25a. In order to clamp the grip portion 25a between the recesses of the first member 28a and second member 28b, the first member 28a and the second member 28b of the clamp means 28 supported by the base portion 27 are fittably inserted in the recessed groove which defines the grip portion 25a. The first member 28a and the second member 28b are secured to each other with bolts 28c whereby the grip portion 25a is grasped by the clamp means 28.

As described above, the resonator 21 has the structure in which the center axis of the resonator 21 is substantially in the same direction as that of the screw hole 27a. Namely, the direction of the center axis of the resonator 21 substantially coincides with the direction in which the resonator 21 is moved by the drive mechanism 4 (the direction, indicated by the arrowed line 2 in FIG. 1). The resonator is supported by the support means 24 in a manner that the resonator directs the cutting edge 23 of the cutting blade 23 to the stage 3. The base portion 27 is lowered by the drive mechanism 4 whereby the resonator 21 together with the base portion 27 is moved to the stage 3. Thus, the drive mechanism 4 applies the pressure force onto the cutting object on the top surface 31 of the stage 3 by means of the cutting edge 23a of the cutting plate 23, so that the object is cut by the cutting blade 23.

The clamp means 28 may preferably be formed of pure Ti, Ti alloy, duralumin, Mn—Cu alloy as a kind of interface type damping alloy (twin crystal damping alloy), Mn—Cu—Ni—Fe alloy obtained by admixing Ni, Fe and the like to the Mn—Cu alloy, flake graphite cast iron, ferrite stainless steel or the like. These materials may have a logarithmic decrement of more than 0.01 and less than 1, or more preferably have a logarithmic decrement of 0.1 or above.

On the other hand, a material, such as duralumin as a kind of Al alloy, and Ti alloy, which has a logarithmic decrement of 0.01 or less, may be used to form the clamp means 28 if the material has a sound propagation speed of 5900 m/s or more, or more preferably of 6000 m/s or more.

According to this embodiment, the whole body of the clamp means 28 is formed of the twin crystal damping alloy (e.g., the above-described Mn—Cu—Ni—Fe alloy) which satisfies the both conditions of logarithmic decrement and sound propagation speed. The resonator 21 is supported with the grip portions 25a of the booster 25 grasped, by the clamp means 28 thus formed.

By the way, the twin crystal damping alloy is a material in which crystal: twinning occurs when a load is applied to the material and the twinned crystal is varied in dimensions or migrated according to the magnitude of the load. In conjunction with the format ion and migration of twin crystals, the load is dissipated in conversion of kinetic energy to thermal energy. When the vibration is applied to the twin crystal damping alloy, therefore, the vibration is dissipated in the material so that the vibration propagation is suppressed. Hence, the twin crystal damping alloy is used as a vibration damping material in a variety of fields.

Since the vibration cutting apparatus of this embodiment is designed to utilize the ultrasonic vibrations of the resonator, it is desirable to suppress the abnormal vibrations irrespective of the natural vibrations of the resonator 21 which are originated from the vibrations of the oscillator 22. Further, the resonator 21 per se must perform stable vibrations at a predetermined frequency. Hence, it has been a conventional practice not to use the twin crystal damping alloy as the material for forming the means for supporting the resonator 21. This is because if the twin crystal damping alloy is adopted as a supporting member for the resonator 21, the vibrations of the resonator 21 per se may also be suppressed.

After the variety of experiments so made, the present inventors found that is the twin crystal damping alloy is used as the supporting member for the resonator 21, the resonator 21 is less prone to the abnormal vibrations such as lateral, wobbling and the vibrations of the resonator 21 per se are not disturbed. That is, the resonator is allowed to vibrate stably at the predetermined frequency. This is considered to be the result of that the twin crystal damping alloy makes frequency following response to vibrations in a so-called ultrasonic frequency band, thus consecutively generating microscopic twin crystals in the material mass. Hence, the twin crystal damping alloy is suitable for use as the supporting member for supporting the resonator 21 exhibiting the ultrasonic vibrations 11 is most desirable to form the clamp means 28 using the Mn—Cu—Ni—Fe alloy obtained by further adding Ni, Fe or the like to the Mn—Cu alloy, a kind of twin crystal damping alloy.

The material for the clamp means 28 is not limited to the twin crystal damping alloy. Any material that has a logarithmic decrement in the range of 0.01 to 1 or has a sound propagation speed of 5900 m/s or more is usable. The support means 24 may be formed in any configuration or dimensions so long as at least a part of the clamp means 28 that is in contact with the grip portion 25a of the resonator 21 is formed of the above-described material.

The structure of the support means 24 for supporting the resonator 21 is not limited to the clamp means 28 shown in FIG. 5 that grasps the grip portion 25a formed at the booster 25 and that is fixed thereto by means of the bolts 28c. For example, the support means 24 may employ a mechanical clamp mechanism of an electrically controllable design or a clamp mechanism mount able in one step. That is, the support means may have any structure that is adapted to support the resonator by grasping the grip portions 25a without interposing the elastic vibration absorbing material between the support means and the resonator, unlike in the case of the conventional practice where the vibration absorbing material is interposed between the support means and the resonator.

The locations of the grip portions formed at the resonator 21 are not limited to the points of minimum oscillation f1, f3. The grip portions may be formed at any positions on the resonator 21. The configuration of the grip portion 25a is not limited to the recess but may include any shape such as projection.

### (Cutting Operation)

Next, an example of an operation of cutting the cutting object placed on the top surface 31 of the stage 3 is described with reference to FIG. 6.

First, the controller 6 enables free movement of the copying mechanism 32 and drives the drive mechanism 4 to move the resonator 21 in standby position to the stage. Thus, the cutting edge 23a of the cutting blade 23 is pressed against the top surface 31. The copying mechanism 32 is moved by a moment generated by pressing the cutting edge 23a against the top surface 31. When the top surface is inclined in conformity with the inclination of the cutting edge 23a so that the inclination of the top surface 31 matches the inclination of the cutting edge 23a, the controller disables the movement of the copying mechanism 32, fixing the inclination of the top surface 31 (Step 31). Subsequently, the drive mechanism 4 is driven to move the resonator 21 upward to the standby position.

Subsequently, a cutting object (work piece) such as a green sheet laminate is placed, on the top surface 31 of the stage 3 (Step S2). Relative position between the cutting edge 23a and the object on the top surface 31 is recognized by the position recognition means 5 inserted between the cutting edge 23a and the stage 3, The cutting edge 23a and the object on the top surface 31 are brought into alignment by driving the stage 3 based on the relative position thus recognized (Step S3).

The drive mechanism 4 starts to move the resonator 21 downward (Step S4). The resonator 21 is brought into vibration by applying a drive signal to the oscillator 22 (Step S5). At this time, drive torque of the driving motor 41 of the drive mechanism 4 is controlled such chat the drive mechanism 4 may move the resonator 21 to the stage 3 in a manner to allow the cutting blade 23 to apply a constant pressure force of a predetermined value to the object on the top surface 31 (Step S6).

When the cutting of the object is completed, the resonator 21 is moved upward to the standby position while the stage 3 is driven to set the object to the next cutting position (Step S7). Steps S3 to S7 are repeated till the object is cut at all the defined cutting positions (‘No’ in Step S8). When the object is cut at all the defined cutting positions (‘Yes’ in Step S8), the operation is terminated.

The magnitude of the pressure force which the cutting blade 23 applies to the object on the top surface 31 may be set such that the degree of edge bending caused by cutting the object is within allowance limits of cutting precision required of the cutting blade. The degree of edge bending caused by cutting the object is determined by performing a cutting test on the object.

### (First Exemplary Modification of Resonator)

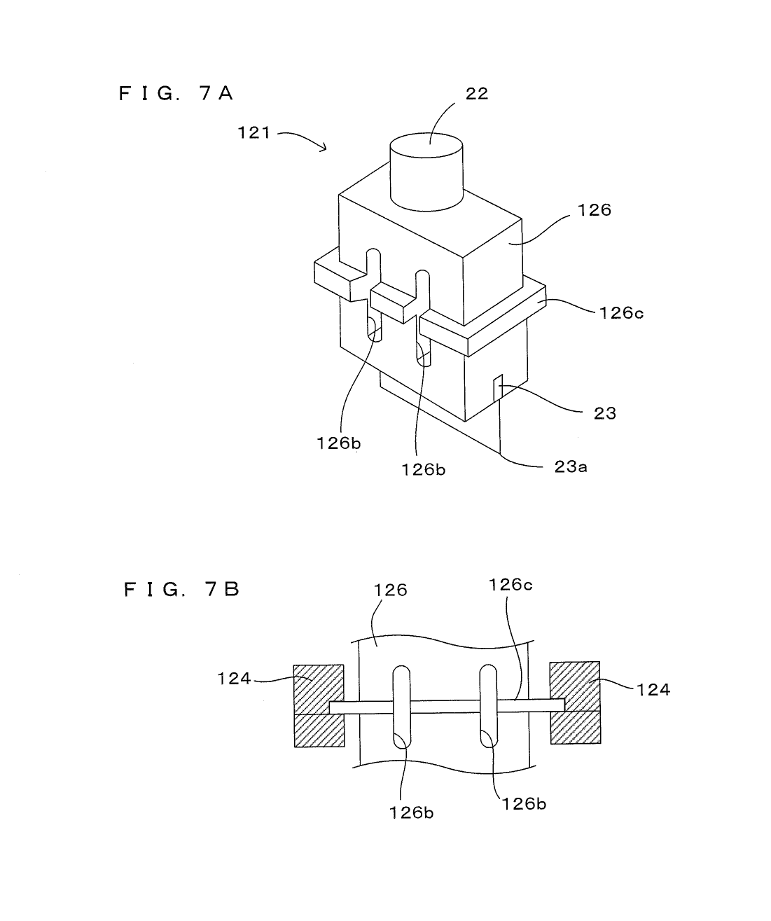

FIG. 7 is a group of diagrams showing a first exemplary modification of the resonator. FIG. 7A is a perspective view of the resonator and FIG. 7B is a fragmentary sectional view thereof. As shown in FIG 7A, a resonator 121 according to the first exemplary modification includes a horn 126 formed in a rectangular parallelepiped. The horn 126 has a first end connected to the oscillator 22 and a second end (opposite to the oscillator 22) mounted with the cutting blade 23, just as in the above-described embodiment.

Similarly to the above-described embodiment, the horn 126 includes two elongated holes 126b cut through a lateral side thereof and extended substantially in parallel to the center axis of the horn 126. The center axis of the horn 126 is equivalent, to the vibration direction of the oscillator 22. That is, the degree of amplitude of the vibrations at the second end of the horn 126 is adjusted across the width thereof. Hence, the vibrations adjusted in the degree of amplitude across the width are applied, to the cutting blade 23.

Similarly to the horn 26 shown in FIG. 3, the horn 126 is formed in the wavelength of one-half cycle of the resonant wave such that the opposite end positions of the horn 126 may coincide with the points of maximum oscillation amplitude. In this case, a substantial central position of the horn 126 coincides with a point, of minimum oscillation amplitude. Further, the horn 126 is formed with a projected grip portion 126c on an outer periphery thereof at the substantial central position, or at the point of minimum oscillation amplitude. As shown in FIG. 73, the projected grip portion 126c formed on the outer periphery of the horn 126 is clampingly grasped by the support means 124 whereby the resonator is supported, by the support means 124, The other components and the operations thereof are the same as in the above-described embodiments and hence, the description thereof is dispensed with.

### (Second Exemplary Modification of Resonator)

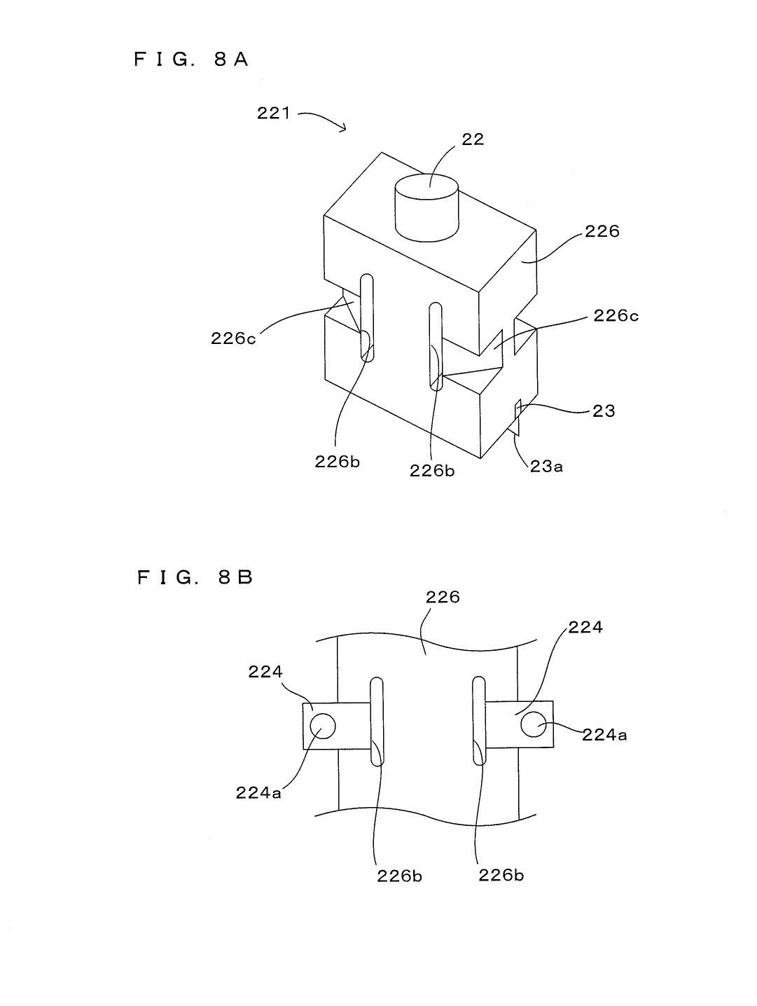

FIG. 8 is a group of diagrams showing a second exemplary modification of the resonator. FIG. 8A is a perspective view of the resonator and FIG. 8B is a fragmentary enlarged view thereof. As shown in FIG. 8A, a resonator 221 according to the second exemplary modification includes a horn 226 formed in a rectangular parallelepiped. The horn 226 has a first end connected to the oscillator 22 and a second end (opposite to the oscillator 22) mounted with the cutting blade 23, just as in the above-described embodiment.

Similarly to the above-described embodiment, the horn 226 includes two elongated holes 226b cut through a lateral side thereof and extended substantially in parallel to the center axis of the horn 226. The center axis of the horn 226 is equivalent to the vibration direction of the oscillator 22. That is, the degree of amplitude of the vibrations at the second end of the horn 226 is adjusted across the width, thereof. Hence, the vibrations adjusted in the degree of amplitude across the width are applied to the cutting blade 23.

Similarly to the horn 26 shown in FIG. 3, the horn 226 is formed in the wavelength of one-half cycle of the resonant wave such that the opposite end positions of the horn 226 may coincide with the points of maximum oscillation amplitude. In this case, a substantial central position of the horn 226 coincides with a point of minimum oscillation amplitude. Further, the horn 226 is formed with a recessed grip portion 226c in an outer periphery thereof at the substantial central position or the point of minimum oscillation amplitude. As shown in FIG. 8B, the recessed grip portion 226c formed in the outer periphery of the horn 226 is clampingly grasped by a member of the support means 224, which member is fastened with a screw 224a, so that the resonator is grasped and supported by the support means 224. The other components and the operations thereof are the same as in the above-described embodiments and hence, the description thereof is dispensed with.

### (First Exemplary Modification of Cutting Blade)

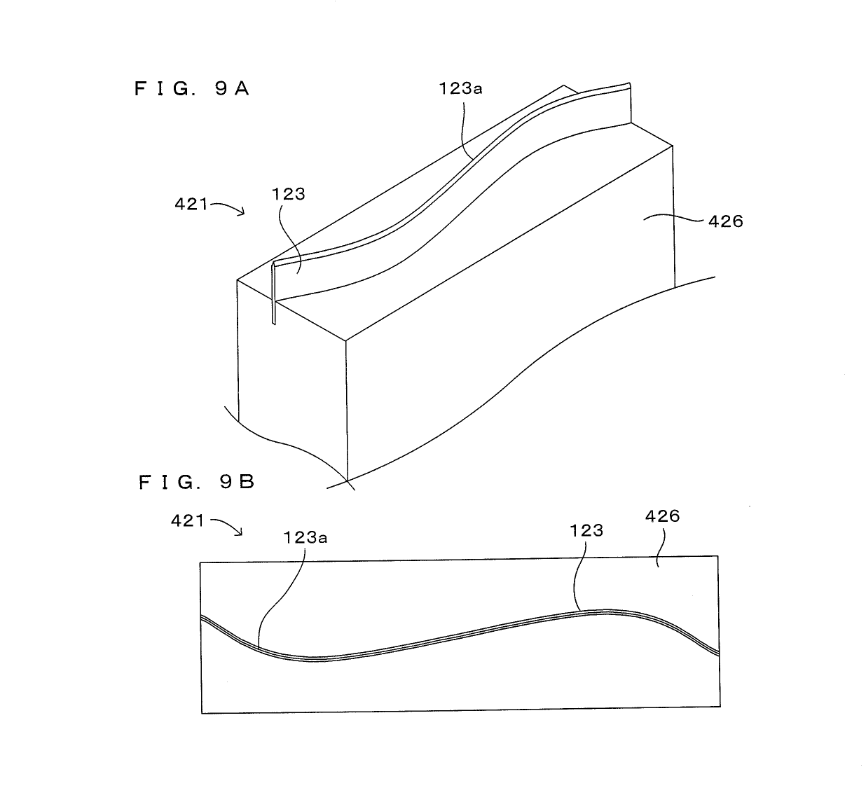

FIG. 9 is a group of diagrams showing a first exemplary modification of the cutting blade. FIG. 9A is a perspective view showing the horn in an upside-down position and FIG. 9B is a bottom plan view thereof. In is noted that FIG. 9 depicts a resonator 421 in a bottom side up fashion. As shown in FIG. 9A and FIG. 9B, the resonator 421 according to this exemplary modification includes a horn 4 26 formed in a rectangular parallelepiped. The horn 426 has a second end mounted with a cutting blade 123 in the same way as in the above-described embodiment. The cutting blade 123 has a cutting edge 123a formed in a curved line as seen from below.

The cutting blade 123 formed in this configuration is adapted to cut a thin metal film or the like into a predetermined configuration with precision.

According to the above described embodiments, the resonator 21 (the resonator 121, 221, 421) with the grip portion 25a (the grip portion 126c, 226c) grasped by the clamp means 28 (the support means 124, 224) is supported by the support means 24 (the support means 124, 224). Unlike in the case of the conventional practice, the resonator 21 (the resonator 121, 221, 421) is supported by the support means 24 (the support means 124, 224) without interposing the elastic vibration absorbing material between the support means and the resonator, whereby the resonator 21 (the resonator 121, 221, 421) is prevented from suffering the occurrence of abnormal vibrations which include lateral wobbling and the like in the different direction from that of the natural vibrations of the oscillator 22 connected to the first end of the resonator 21 (the resonators 121, 221, 421).

The flat-plate cutting blade 23 (the cutting blade 123) is mounted to the resonator 21 (the resonator 12 1, 221, 421) in a manner that the second end of the cutting blade 23 (the cutting blade 123), which is opposite from the first end formed with the cutting edge 23a (the cutting edge 123a), is fitted in the mating groove 26a formed in the second end of the resonator 21 (the resonator 121, 221, 421) and that the second end of the cutting blade 23 (the cutting blade 123) is bonded to the mating groove 26a on the opposite lateral sides across the width thereof. Since at least one elongated hole 26b (the elongated hole 126b, 226b) is cut through the lateral side of the resonator 21 (the resonator 121, 221, 421), the vibrations are adjusted in the degree of amplitude across the width of the cutting blade 23 (the cutting blade 123) at the second end of the resonator 21 (the resonator 121, 221, 421). Thus, the vibrations adjusted in the degree of amplitude across the width can be applied to the cutting blade 23 (the cutting blade 123) and hence, the apparatus can precisely cut the object with the cutting blade 23 (the cutting blade 123) subjected to the appropriately conditioned, vibrations.

The resonator 21 (the resonator 121, 221, 421) can invert the phase of the vibrations at the. individual areas on either side of the elongated hole 26b (the elongated hole 126b, 226b) thereof. Furthermore, resonator 21 (the resonator 121, 221, 421) can also adjust properly the amplitude of the vibrations at the individual areas.

When the cutting blade 23 (the cutting blade 123) is bonded to the mating groove 26a of the resonator 21 (the resonator 121, 221, 421), the brazing metal, solder or the adhesive agent such as a thermosetting adhesive is filled in the recessed grooves 23b formed in the opposite lateral sides of the second end of the cutting blade 23 (the cutting blade 123) and extended across the width thereof. Therefore, the cutting blade 23 (the cutting blade 123) can be assuredly bonded to the mating groove 26a formed at the resonator 21 (the resonator 121, 221, 421).

The cutting blade 23 (the cutting blade 123) is adapted to cut the object with the cutting edge 23a (the cutting edge 123a) inclined at substantially the same angle as the top surface 31 of the stage 3. When cutting the object, the cutting blade 23 (the cutting blade 123) cuts into the object by substantially an equal amount across the width of the cutting edge 23a (the cutting edge 123a). This permits the cutting blade 23 (the cutting blade 123) to be pressed into the object by the minimum necessary amount for cutting the object and hence, the wear of the cutting blade 23 (the cutting blade 123) can be suppressed.

The drive mechanism 4 moves the resonator 21 (the resonator 121, 221, 421) toward the stage 3 in such a manner as to maintain the pressing force, applied by the cutting blade 23 (the cutting blade 123) to the object, at the predetermined constant value that ensures that the degree of edge bending of the cutting blade 23 (the cutting blade 123) is within the allowance limits of cutting precision required of cutting the object. Accordingly, a speed at which the cutting blade 23 (the cutting blade 123) is pressed into the object is automatically regulated in conjunction with the controlled pressure force. Hence, the cutting blade 23 (the cutting blade 123) is pressed into the object at the highest speed that provides the degree of edge bending of the cutting blade 23 (the cutting blade 123) to within the above-described allowance limits of cutting precision. With the edge bending of the cutting blade 23 restricted to within the above-described allowance limits of cutting precision, the apparatus can achieve the increase in efficiency of cutting work on the object.

### Second Embodiment

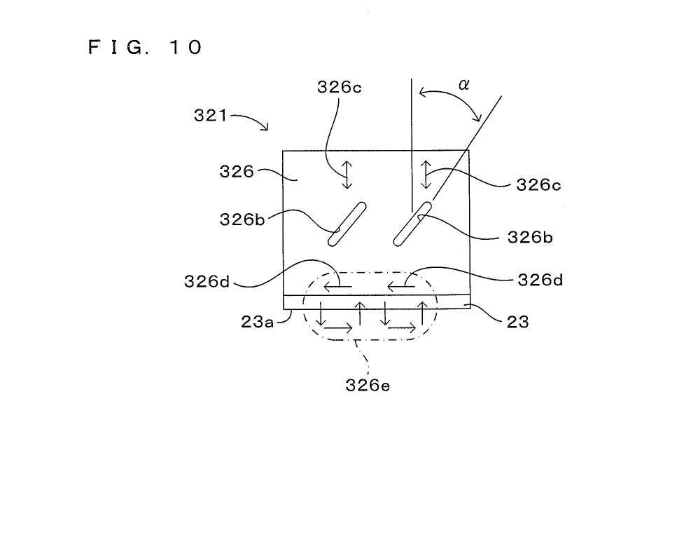

A second embodiment of the vibration cutting apparatus according to the invention is described with reference to FIG. 10. FIG. 10 is a diagram showing a resonator 321 according to the second embodiment of the vibration cutting apparatus 1 of the invention. As shown in FIG. 10, the resonator 321 of this embodiment differs from the resonator 21 of the above first embodiment in that elongated holes 326b inclined relative to the vibration direction of the oscillator 22 are cut through a lateral side of a horn 326 of the resonator 321. Since the other components and the operations thereof are the same as in the above-described first embodiment, the following description focuses on the difference from the first embodiment. Identical reference numerals refer to the corresponding components of the above-described first embodiment and the description on the structures and operations thereof is dispensed with.

As shown in FIG. 10, the resonator 321 of this embodiment includes the horn 326 formed in a rectangular parallelepiped. The cutting blade 23 is mounted to a second end of the horn 326 in the same manner as in the above-described first embodiment.

The elongated holes 326b are cut through the lateral side of the horn 326 as inclined at an angle α (about 45°) to the vibration direction of the oscillator 22. At the second end of the horn 326, the vibrations are adjusted in the magnitude of amplitude and the direction across the width. Specifically, vibrations at an area abutting on a first end of the horn 326 which is opposite to the cutting blade 23 oscillate in a direction of arrowed lines 326c substantially perpendicular to the cutting edge 23a of the cutting blade 23. The vibrations can be converted into vibrations at an area abutting on the second, end of the horn 326, namely at the area across the elongated holes 326b from the area abutting on the first end of the horn. The resultant vibrations contain vibrational components in a direction of arrowed lines 326d substantially parallel to the cutting edge 23a of the cutting blade 23. Thus, the vibrations adjusted (across the width of the cutting blade) in the degree of amplitude and in the direction are applied to the cutting blade 23.

According to this embodiment, as described above, the same effect as that of the above-described first embodiment can be obtained. Furthermore, the vibrational components substantially parallel to the cutting edge 23a are added to the vibrations which are applied, to the cutting blade 23 by the horn 326. Hence, the cutting blade 23 oscillates in vertical and transverse directions in a manner to trace an arc as indicated by arrows of a region enclosed by a dot-dash line in FIG. 10. The object is cut by the cutting blade 23 moved like a kitchen knife, for example, which is used in a manner combining draw cut and push cut. Therefore, the cutting blade 23 is capable of cutting the object with more enhanced cutting performance or with higher precision.

### Third Embodiment

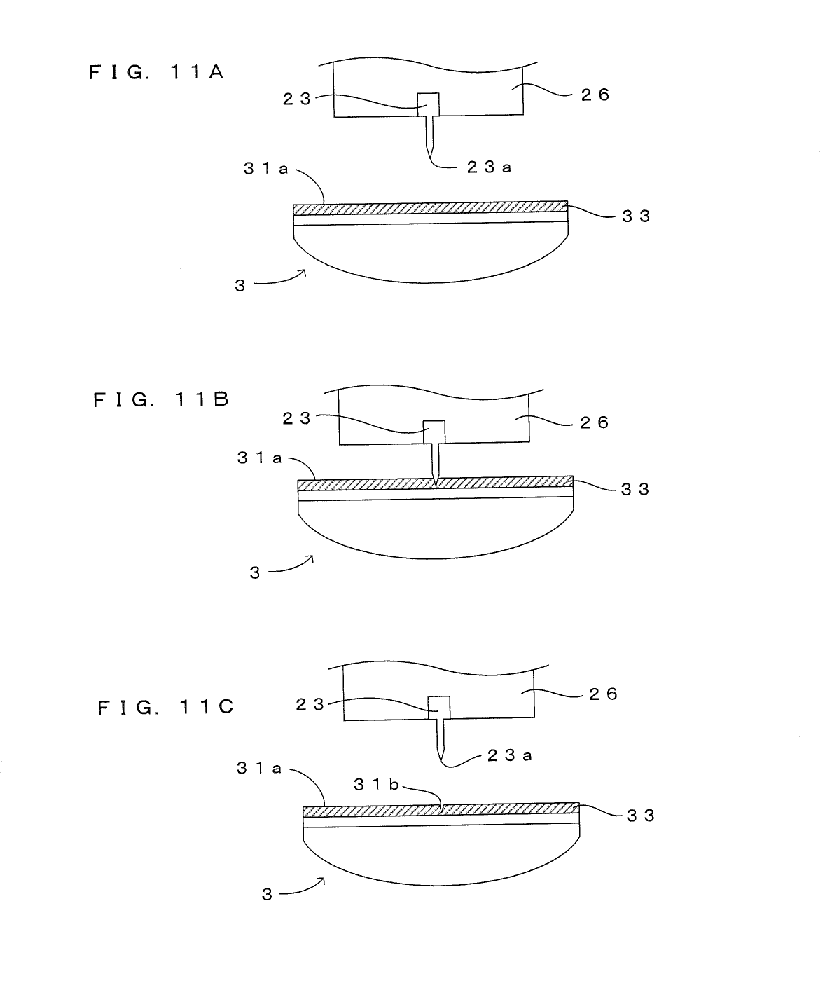

A third embodiment of the vibration cutting apparatus of the invention is described with reference to FIG. 11. FIG. 11 is a group of enlarged views showing essential parts of a horn 26 and a stage 3 according to the third embodiment of the vibration cutting apparatus 1 of the invention. FIG. 11A to FIG. 11C each show a different condition of the essential parts. As shown in FIG. 11A to FIG. 11C, the stage 3 of this embodiment differs from the stage 3 of the first embodiment in that this stage 3 includes a buffer layer 33 provided with a top surface 31a on which the cutting object is placed. Since the other components and the operations thereof are the same as in the above-described first embodiment, the following description focuses on the difference from the first embodiment. Identical reference numerals refer to the corresponding components of the above-described first embodiment and the description on the structures and operations thereof is dispensed with.

As shown in FIG. 11B and FIG. 11C, the buffer layer 33 is formed of a resin material such as polyimide which allows the cutting blade 23 to cut in. As shown in FIG. 11B, the drive mechanism A moves down the cutting blade 23 and forces the cutting edge 23a into the buffer layer 33 so that a notch 31b is formed by the cutting blade 23 in the top surface 31a of the buffer layer 33 (see FIG. 11C).

According to this embodiment, therefore, the same effect as that of the above-described first embodiment can be obtained. Furthermore, the cutting blade 23 forms the notch 31b in the top surface 31a of the buffer layer 33, on which top surface the object is placed. The notch 31b formed by the cutting blade 23 has substantially the same thickness as that of the cutting blade 23 so that the notch can prevent cut ends of the object from being pushed into the notch 31b by the cutting blade 23 cutting the object. Hence, cutout pieces from the object can be shaped with high precisions.

Even if the cutting operation encounters misalignment between the notch 31b formed in the top surface 31a and the cutting edge 23a of the cutting blade 23, breakage of the cutting blade 23 can be prevented because the buffer layer 33 is formed of the material that allows the cutting blade 23 to cut therein.

The material for the buffer layer 33 is not limited to the above and various materials are usable including polyethylene terephthalate and paper, which allow the cutting blade to cut in.

### Fourth Embodiment

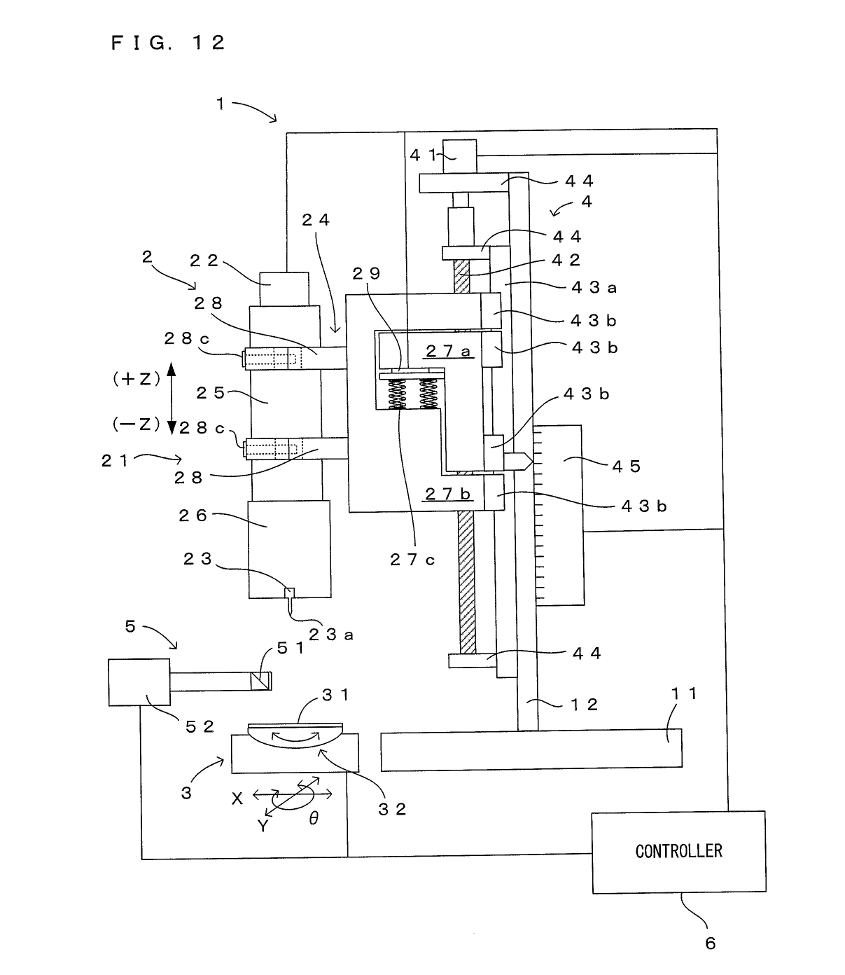

A fourth embodiment of the vibration cutting apparatus of the invention is described with reference to FIG. 12. FIG. 12 is a diagram showing the fourth embodiment of the vibration cutting apparatus 1 of the invention. As shown in FIG. 12, this embodiment differs from the above-described first embodiment in that the clamp means 23 is mounted to a base portion 27b coupled to a base portion 27a via urging means 27c such as spring. Since the other components and the operations thereof are the same as in the above-described first embodiment, the following description focuses on the difference from the first embodiment. Identical reference numerals refer to the corresponding components of the above-described first embodiment and the description on the structures and operations thereof is dispensed with.

As shown in FIG. 12, the base portion 27a is mounted to the ball screw 42 via threadable engagement between a screw hole (not shown) extended through the base portion 27a and the ball screw 42. Under the control of the controller 6, the drive means 4 drives the ball screw 42 thereby moving up or down the base portion 27a threadably engaged with the ball screw 42. The base portion 27b is formed with a through hole (not shown) allowing the ball screw 42 to extend therethrough, and is coupled to the base portion 27a via the urging means 27c.

The urging means 27c has a function to cancel the self-weight of the head portion 2 exclusive of the base portion 27a so that the resonator 21 (the base portion 27b) is supported by the support means 24 as urged upward by the urging means 27c.

Pressure detecting means 29 such as load cell is provided at a connecting portion between the base portion 27a and the base portion 27b, so as to detect a pressure force applied to the object by the cutting blade 23. The controller 6 controls the drive mechanism 4 based on a detection signal from the pressure detecting means 29, thereby controlling the pressure force applied to the object, by the cutting blade 23.

According to this embodiment, as described above, the same effect as that of the above-described first embodiment can be obtained. Furthermore, the controller provides feedback control of the drive mechanism 4 based on the detection signal from the pressure detecting means 29 so as to control the pressure force applied to the object by the cutting blade 23 to a predetermined value without being affected by frictional force or the like occurring at the threaded engagement area between the bail screw 42 and the base portion 27a.

### Fifth Embodiment

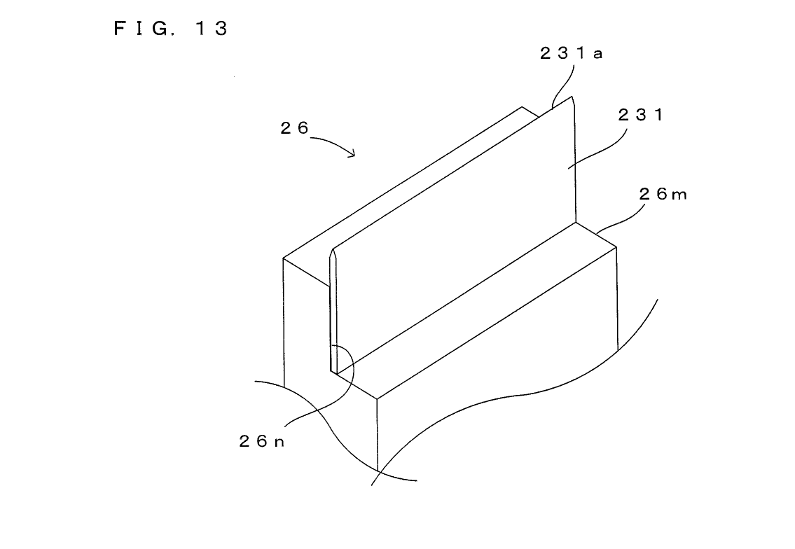

A fifth embodiment of the vibration cutting apparatus of the invention is described with reference to FIG. 13. FIG. 13 is a diagram showing the fifth embodiment of the vibration cutting apparatus 1 of the invention. As shown in FIG. 13, this embodiment differs from the above-described first embodiment in that a step portion 26m having an L-shaped cross section is formed by partially cutting away an end surface of the second end of the horn 26, the second end defining the mounting portion, and that a cutting blade 231 shaped like a rectangular flat plate is bonded to a mounting surface 26n (parallel to the vibration direction of the horn 26) of the step portion 26m with an adhesive agent. The other components and the operations thereof are the same as in the above-described first embodiment. In the following description, therefore, identical reference numerals refer to the corresponding components of the above-described first embodiment and the description on the structures and operations thereof is dispensed with.

As shown in FIG. 13, the step portion 26m having the L-shaped cross section is formed at the second end of the horn 26, as the mounting portion, by partially cutting away the end surface of the second end thereof, The cutting blade 231 is fixed to the mounting surface 26n of the step portion 26m with an adhesive agent, which mounting surface is parallel to the vibration direction of the horn 26. In this case, the cutting blade 231 is mounted to the horn 26 in a manner that the cutting blade 231 exclusive of a cutting edge 231a on the first end thereof is bonded to the mounting surface 26n as abutting on the mounting surface 26n on a lateral side of the second end portion thereof. The material for bonding the cutting blade 231 is not limited to the adhesive agent, The cutting blade 231 may also be fixed to the mounting surface with a brazing metal.

This embodiment negates the need for forming a groove at the mounting portion of the second end of the horn 26 for fittingly receiving the cutting blade 231, The embodiment permits the cutting blade to be easily fixed to the mounting surface with the adhesive agent or the like.

### (Second Exemplary Modification of Cutting Blade)

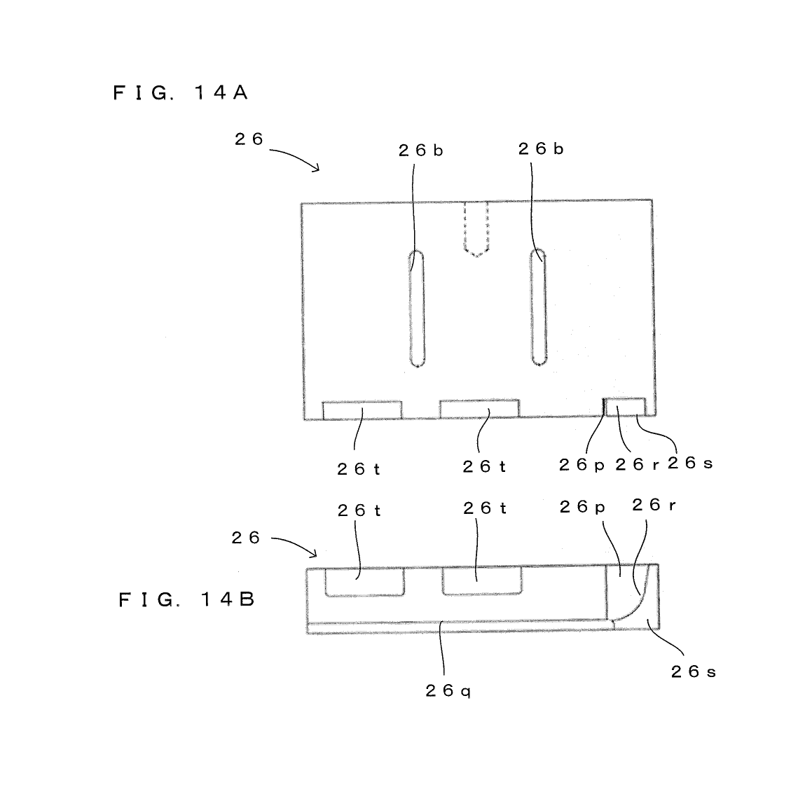

FIG. 14 shows an exemplary modification of mounting of the cutting blade 231 of the fifth embodiment. FIG. 14A is a front view of the horn and FIG. 14B is a bottom plan view thereof. As shown FIG. 14, a step portion 26a having an L-shaped cross section is formed at the second end of the horn 26, as the mounting portion, by partially cutting away a rear side and a right aide of the end surface of the second end. The cutting blade 231 exclusive of a right end thereof is fixed to a mounting surface 26q on a rear side of the step portion 26p with an adhesive agent, the mounting surface 26g extending in parallel to the vibration direction oaf the horn. 26. The right end of the cutting blade 231 is conformingly fixed, with the adhesive agent, to a guide surface 26r of a guide portion 26s formed at a right end of the second: end surface of the horn 26. The curved guide surface 26r extends in parallel to the vibration direction of the horn 26. It is noted here that the step portion 26p is actually formed by cutting the end surface or the second and of the horn 26 in a manner to leave the guide, portion 26s.

Thus, the cutting blade 231 curved at the right end thereof is mounted to the horn 26 so as to be adapted for cutting the object into a curved, configuration. The guide portion 26s retains the curved end of the cutting blade 231 in a direction in which the curved end of the cutting blade 231 tends to restore to its original configuration. That is, the guide portion 26s can retain the end of the cutting blade 231 in the curved position, thus preventing the cutting blade 231 from being separated from the curved portion of the horn due to the vibrations during the cutting operation. Indicated at 26t in FIG. 14 is a notch formed at two places on a front end portion of the second end of the horn 26, as the mounting portion. The notches are formed, to equalize the amplitude of the vibrations across the cutting edge, the vibrations applied to the cutting blade 231 mounted in the curved position to the horn 26. The material for bonding the cutting blade 231 is not limited to the adhesive agent. The cutting blade 231 may also be fixed with the brazing metal.

### Sixth Embodiment

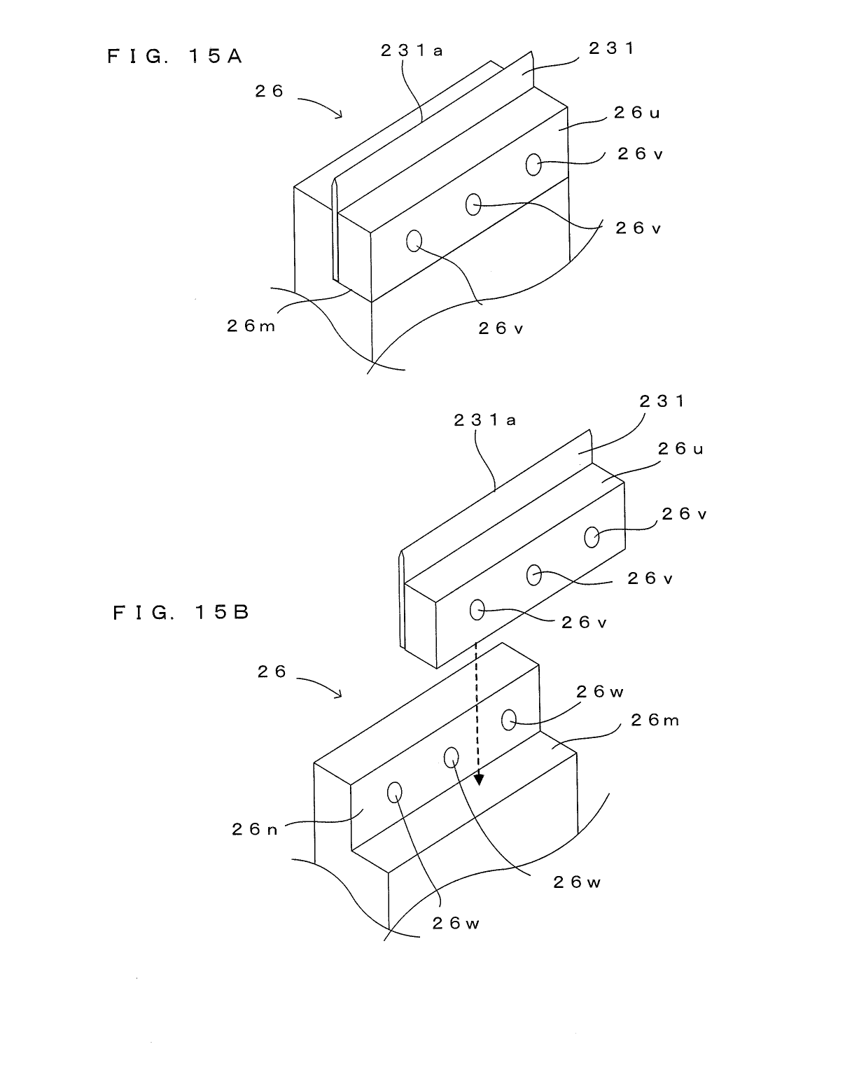

A sixth embodiment of the vibration cutting apparatus of the invention is described with reference to FIG. 15. FIG. 15 is a group of diagrams showing the sixth embodiment of the vibration cutting apparatus 1 of the invention. As shown in FIG. 15, this embodiment differs from the above-described fifth embodiment in that the cutting blade 231 is mounted to the horn 26 in a manner such that the cutting blade 231 exclusive of the cutting edge 231a is bonded to a mounting base 25u and the cutting blade 231 together with the mounting base 26u is secured to the mounting surface 26n of the step portion 26m with bolts. The other components and the operations thereof are the same as in the above-described fifth embodiment. In the following description, therefore, identical reference numerals refer to the corresponding components of the fifth embodiment and the description on the structures and operations thereof is dispensed with. It is noted that FIG. 15 shows a portion near the second end of the horn 26 in an upside-down position, FIG. 15A is a perspective view showing the second end of the horn 26 and the vicinity thereof, and FIG. 15B is a partly exploded, perspective view thereof.

As shown in FIG. 15, the mounting base 26u is provided for clamping the cutting blade 231 between the mounting base 26u and the mounting surface 26n of the step portion 26m. The mounting surface 26n extends in parallel to the vibration direction of the horn 26 and the step portion 26m is formed in the end surface of the second end, as the mounting portion, of the horn 26. The cutting blade 231 exclusive of the cutting edge 231a is bonded, with an adhesive agent, to a side of the mounting base 26u that is in opposed relation to the mounting surface 26n. A plurality of bolt through holes 26v (three bolt through holes formed in this embodiment) are formed through the bonded cutting blade 231 and the mounting base 26u. The mounting surface 26n is formed with female threads 26w at places corresponding to the bolt through holes 26v. The cutting blade 231 exclusive of the cutting edge 231a is bonded to the mounting base 26u, so that the cutting blade 231 together with the mounting base 26u is mounted to the mounting surface 26n by inserting and threadably engaging bolts (not shown) in and with the respective bolt through holes 26v and female threads 26w. The material for bonding the cutting blade 231 is not limited to the adhesive agent, The cutting blade 231 may also be fixed with the brazing metal. FIG. 15 illustrates the example where the bolts are inserted from a lateral side of the mounting base 26u. However, the mounting base 26u may also be secured to the horn 26 with the bolts threadably engaged with the step portion 26m of the horn 26. This approach negates the need for forming the bolt through holes in the cutting blade 231 secured to the mounting base 26u.

According to the above-described embodiment, therefore, the cutting blade 231 can be more reliably mounted to the horn 26 because the cutting blade 231 exclusive of the cutting edge 231a is bonded to the mounting base 26u and the mounting base 26u together with the cutting blade 231 is secured to the mounting surface 26n with the bolts.

### (Third Exemplary Modification of Resonator)

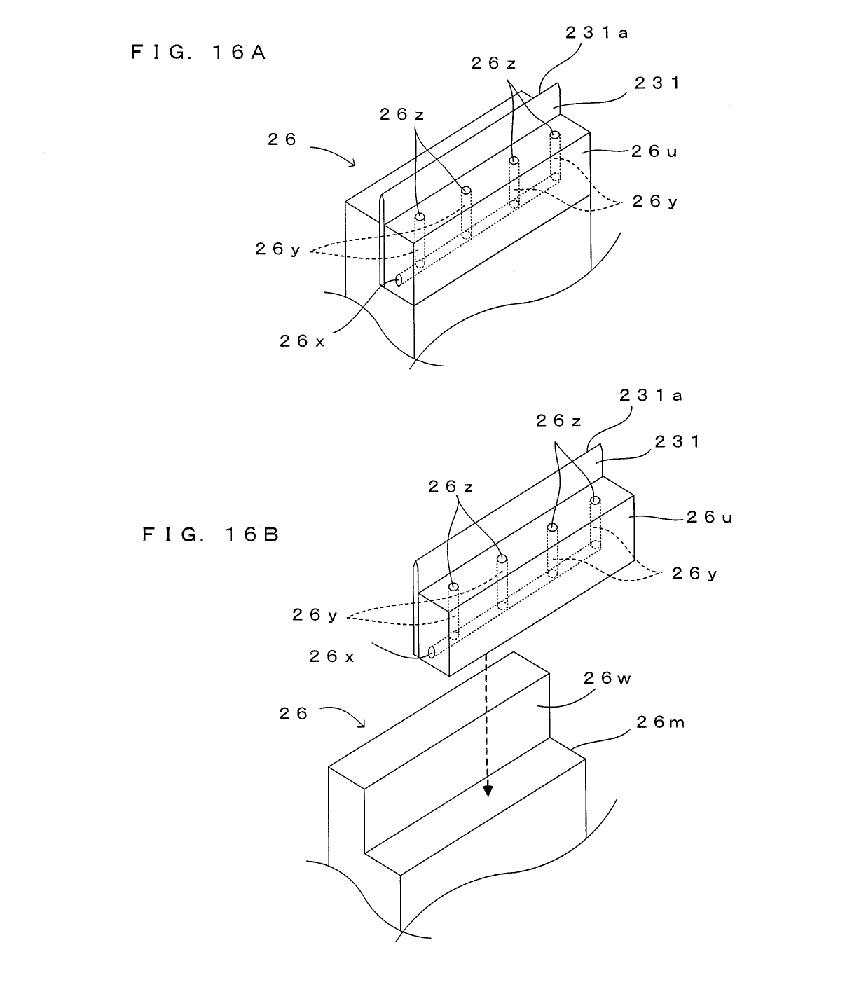

FIG. 16 shows a third exemplary modification of the horn 26 according to the sixth embodiment. FIG. 16A is a perspective view showing a portion near the second end of the horn 26 in an upside-down position and FIG. 16B is a partly exploded perspective view thereof. As shown in FIG. 16, a draft air duct 26x for cooling air may be extended from a left lateral side of the mounting base 26u. Further, draft air ducts 26y may be formed for communicating this draft air duct 26x with a plurality of air outlets 26z (four air outlets formed in this embodiment) that are formed in a bottom surface of the mounting base 26u and discharge the cooling air toward, the vicinity of the cutting edge 231a of the cutting blade 231. This configuration is adapted to feed the cooling air from an unillustrated air source into the draft air duct 26x (the draft air ducts 26y) and to blow out the cooling air from the individual air outlets 26z toward the cutting edge 231a, thereby cooling the cutting edge 231a of the cutting blade 231 which is heated due to friction associated with the cutting operation, The cutting blade 231 becomes less susceptible to failure, wear, or degradation caused by the temperature rise, thus achieving an extended service life. This prevents the apparatus from being decreased in cutting efficiency. In this case, the draft air ducts 26y may be configured as follows. The draft air ducts 26y may be inclined only at portions near the air outlets 26z or otherwise, the whole bodies of the draft air ducts 26y may be inclined so that the air outlets 26z of the draft air ducts 26y may be located closer to the cutting blade 231 thereby blowing the cooling air onto the cutting blade 231 efficiently. Such a cooling method is also applicable to the horns according to the above-described first to fifth embodiments. It is also possible to dispose the draft air ducts 26x, 26y and the air outlets 26z at the main body of the horn 26. Further, fragments, trashes and dusts resulting from cutting the object can be vacuumed up by sucking air from the draft air ducts 26x, 26y via the air outlets 26z.

### Seventh Embodiment

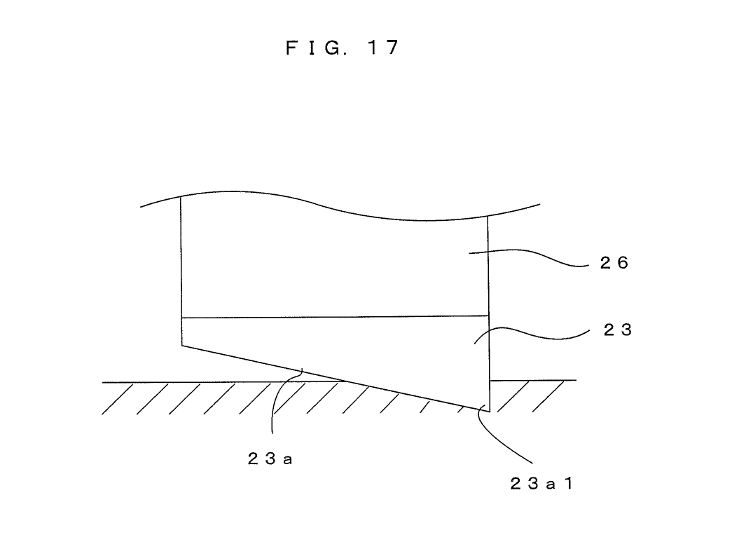

A seventh embodiment of the vibration cutting apparatus of the invention is described with reference to FIG. 17. FIG. 17 is a diagram showing the seventh embodiment, of the vibration cutting apparatus 1 of the invention. As shown in FIG. 17, this embodiment differs from the above-described first embodiment in that, the cutting edge 23a of the cutting blade 23 is formed with a pointed tip 23a1 at a distal end thereof.

According to the above embodiment, the cutting apparatus is capable of cutting the object into a complicated configuration by cutting the object while moving the object relative to the cutting blade 23. The cutting apparatus is also capable of cutting the object, into a fine configuration. A practical cutting part of the cutting edge 23a can be varied by changing the vertical position of the cutting edge 23a of the cutting blade 23 relative to the object. This provides for a method in which the cutting edge 23a is divided into a plurality of regions, each of which can be selectively used. This leads to an extended service life of the cutting blade 23. It is noted that even a rectangular flat-plate cutting blade 23 without, the pointed tip 23a1 at the cutting edge 23a can obtain the same life extending effect as that of the above-described cutting blade 23 if the cutting blade is used in an inclined position relative to the object.

### Eighth Embodiment

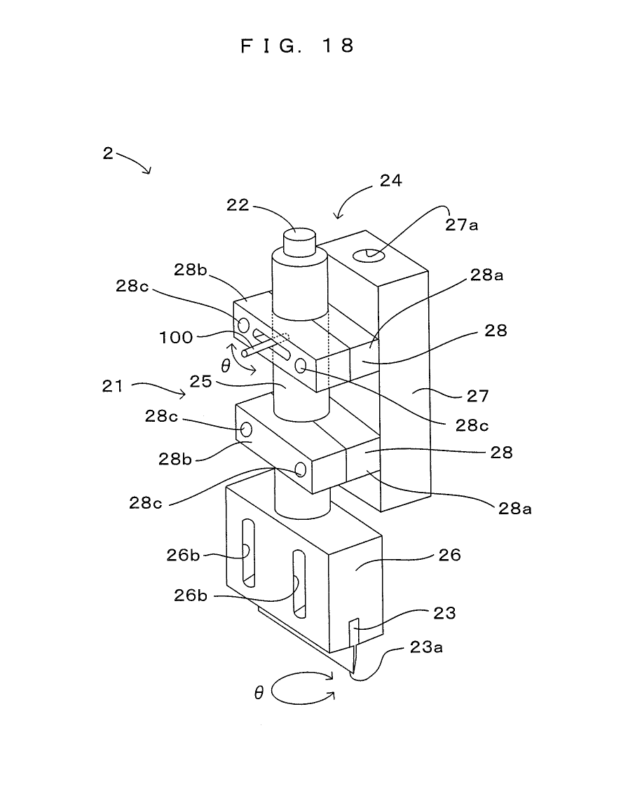

An eighth embodiment of the vibration cutting apparatus of the invention is described with reference to FIG. 13. FIG. 18 is an enlarged view showing an essential part of the eighth embodiment of the vibration cutting apparatus 1 of the invention. As shown in FIG. 18, this embodiment differs from the above-described first embodiment in that a lever 100 for adjusting the orientation of the cutting edge 23a in a θ-direction of the cutting blade 23 is mounted to the resonator 21 as extended through a through hole formed in the clamp means 28. The other components and the operations thereof are the same as in the above-described first embodiment. In the following description, therefore, identical reference numerals refer to the corresponding components of the above-described first embodiment and the description on the structures and operations thereof is dispensed with.

This structure permits the cutting edge 23a to be adjusted in the orientation in the θ-direction of the cutting blade 23 by turning the lever 100 in the θ-direction with the bolts 28c of the clamp means 28 loosened. Therefore, it is easy to make fine adjustment between the orientations of the cutting edge 23a and the object carried on the stage 3. When the fine adjustment between the orientations of the calling edge 23a and the object carried on the stage 3 is accomplished, the bolts 28c of the clamp means 28 may be tightened again to permit the clamp means 28 to grasp the resonator 21. While this embodiment is configured to turn the level 100 manually, the lever 100 may also be turned by an actuator such as a hydraulic cylinder or motor.

### Ninth Embodiment

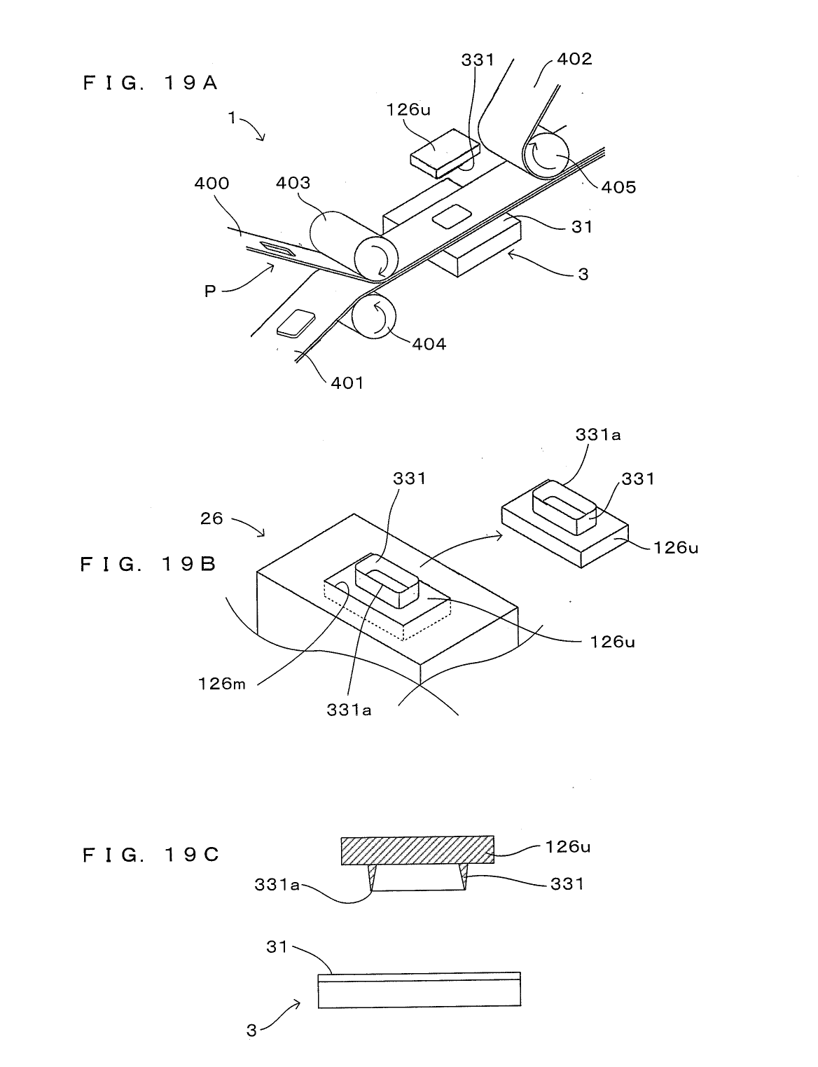

A ninth embodiment of the vibration cutting apparatus of the invention is described with reference to FIG. 19. FIG. 19 is a group of diagrams showing the ninth embodiment of the vibration cutting apparatus 1 of the invention. FIG. 19A is an enlarged view showing an essential part of the vibration cutting apparatus. FIG. 19B is a view showing a portion near the second end of the horn 26 in an upside-down position. FIG. 19C is a partly-sectioned enlarged view showing the stage 3, a cutting blade 331 and the vicinity thereof. As shown in FIG. 19, this embodiment differs from the above-described sixth embodiment in that a mounting base 126u as the mounting portion is shaped like a flat plate, that the cutting blade 331 is secured to a first side of the mounting base 126u and that the mounting base 126u is mounted to the horn 26 in a manner that a second side, of the mounting base 126u is embedded in a mounting groove 126m formed in the second end surface, of the horn 26.

The cutting blade 331 secured to the first side of the mounting base 126a is configured such that a cutting edge 331a thereof defines a predetermined outline. Hence, the cutting apparatus is capable of, for example, cutting out a piece of the predetermined outline from a sheet-like cutting object by cutting the sheet-like cutting object with the cutting blade 331. The other components and the operations thereof are the same as in the above-described sixth embodiment. In the following description, therefore, identical reference numerals refer to the corresponding components of the. above-described sixth embodiment and the description on the structures and operations thereof is dispensed with.

As shown in FIG. 19B and FIG. 19C, the cutting blade 331 is shaped like a tube formed with the cutting edge 331a at a first end thereof. The cutting blade 331 is mounted to the mounting base 126u in a manner that a second end (opposite to the cutting edge 331a) of the cutting-blade is fitted in the mating groove (not shown) formed in the first side of the mounting base 126u and secured to the groove with an adhesive agent or brazing metal. The mounting groove 126m substantially conforming to the configuration of the flat-plate mounting base 126u is formed in the second end surface of the horn 26. The mounting base 126u with the cutting blade 331 secured thereto is embedded in and secured to the mounting groove 126m with the adhesive agent or brazing metal. Thus, the cutting blade 331 is mounted to the second end of the horn 26.

In this embodiment, as shown in FIG. 19A, NCF (Non Conductive Film) 400, a film-like circuit connecting material having both functions of adhesive and insulator is used as the cutting object and cut out into a piece having the outline corresponding to that of the cutting edge 331a of the cutting blade 331. The NCF 400 protected on the both sides by release films 401, 402 is retained and wound on a reel (not shown). The NCF is clamped between a feed roller 403 and a driven roller 404 so as to be unwound from the reel by a required amount and delivered to the stage 3,

As shown in FIG. ISA, the release film 402 covering an upper side of the NCF 400 is separated from the NCF 400 at the position of the pressure roller 405, so that the NCF 400 with only the release film 402 removed from the upper side thereof is placed on the top surface 31 of the stage 3. Then, the drive mechanism 4 lowers the cutting blade 331, by which a piece conforming to the outline of cutting edge 331a of the cutting blade 331 is cut out from the NCF 400.

The NCF 400 so cut is moved away from the stage 3 by the feed roller 403 and the driven, roller 404, at which the NCF 400 is separated from the release film 401 so that the piece cut out from the NCF 400 is left on the release film 401, At a removal position P, the cutout, from the NCF 400 left on the lower release film 401 is removed therefrom to terminate the cutting operation. Since the cutting operation is performed on the NCP 400 protected on the lower side by the lower release film 401, the cutting edge 331a of the cutting blade 331 having cut out the NCF 400 is protected by cutting in the release film 401. This negates the need for providing a protective member for the cutting edge 331a, such as a buffer material, on the top surface 31 of the stage 3.

While the cutting apparatus cuts the NCF 400 as the sheet-like cutting object, the cutting object is not limited to this. Any sheet-like members, such as metal foil of Cu, that permit cutouts therefrom are applicable to the invention.

According to this embodiment, as described above, the same effect as that of the above-described sixth embodiment can be obtained. The cutting blade 331 can be easily mounted to the horn 26 (the resonator) by assembling the flat-plate mounting base 126u with the cutting blade 331 secured to the first side thereof in a manner such that a second side of the mounting base 126u is fixed to the second end of the horn 26,

In this embodiment, the cutting blade 331 is mounted to the mounting base 126u by fitting the cutting blade 331 in the mating groove formed in the first side of the mounting base 126u. However, the cutting blade 331 may also be formed integrally with the mounting base 126u. In this structure, the cutting blade 331 and the mounting base 126u are formed in one piece so that the cutting blade 331 is more rigidly mounted to the mounting base 126u. This reduces the abnormal vibrations of the cutting blade 331 caused by the ultrasonic vibrations of the horn 26 and hence, the cutting apparatus can achieve increased cutting precision.

### (Fourth Exemplary Modification of Resonator)

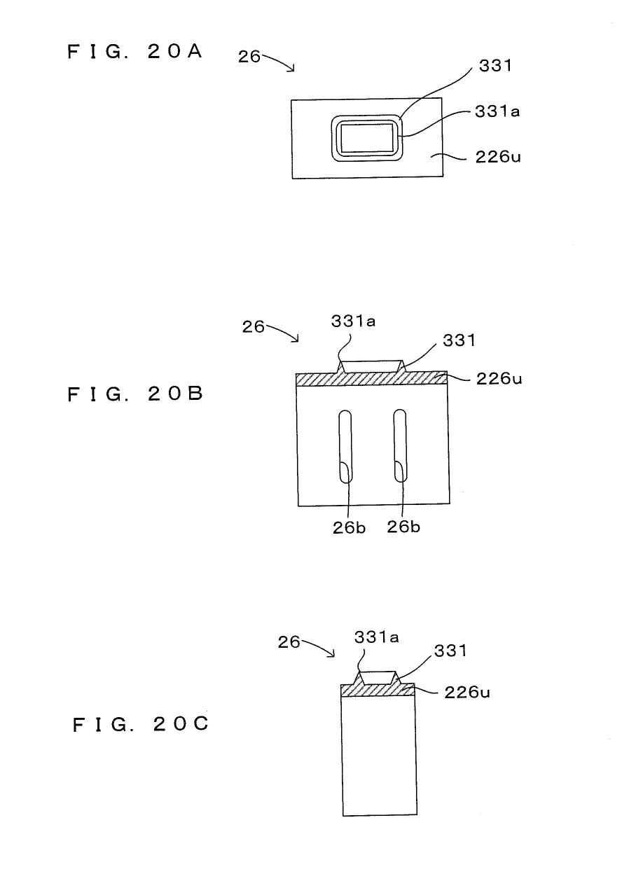

FIG. 20 is a group of diagrams showing a fourth exemplary modification of the horn 26 of the ninth embodiment. FIG. 20A is a bottom plan view of the horn 26. FIG. 20 is a partly-sectioned front view showing the horn 26 in an upside-down position. FIG. 20C is a partly-sectioned side view showing the horn 26 in the upside-down position. In the fourth exemplary modification, the cutting blade 331 is secured to a flat-plate mounting base 226u larger than the above-described mounting base 126u. The cutting blade 331 is mounted to the second end of the horn 26 by way of the mounting base 226u secured to the second end surface of the horn 26 with an adhesive agent or brazing metal. The other components are the same as those of the above-described ninth embodiment and hence are represented by identical reference numerals, the description of which is dispensed with.

### (Fifth Exemplary Modification of Resonator)

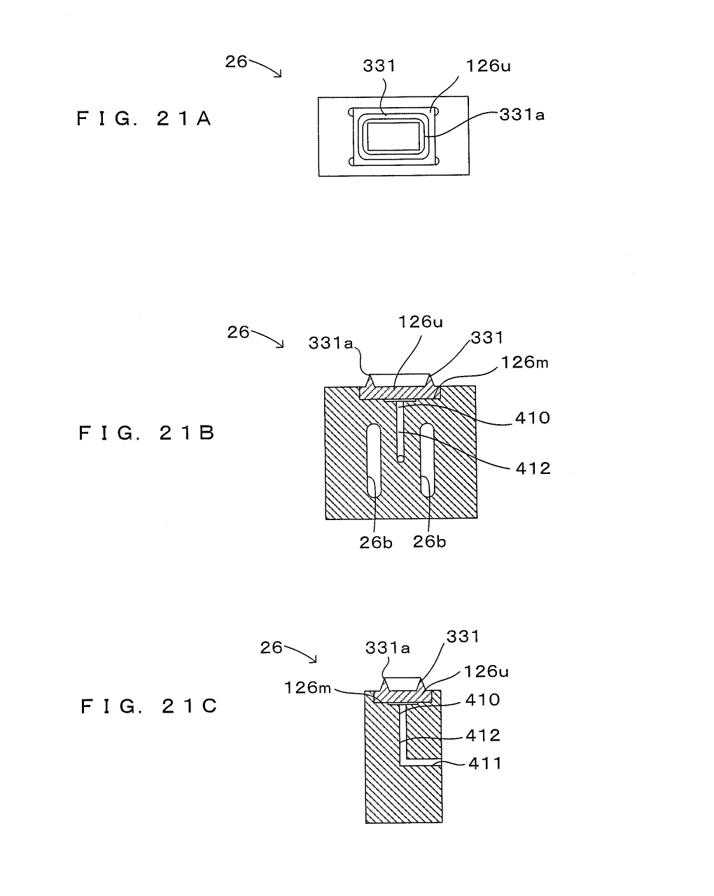

FIG. 21 is a group of diagrams showing a fifth exemplary modification of the horn 26 of the ninth embodiment. FIG. 21A is a bottom plan view of the horn 26. FIG. 21B is a sectional view of the horn 26 in an upside-down position as seen from the front. FIG. 21C is a sectional side view of the horn 26 in the upside-down position.

In the fifth exemplary modification, the horn 26 is formed with a suction hole 412 that communicates a suction orifice 410 formed in a bottom surface of the mounting groove 126m of the horn 26 with a suction orifice 411 formed in a lateral side of the horn 26. An unillustrated suction means sucks air from the suction orifice 411 whereby the reduced pressure causes the mounting base 126u with the cutting blade 331 secured thereto to stick fast to the mounting groove 126m of the horn 26. Thus, the cutting blade is mounted to the horn 26.

This structure permits the cutting blade 331 to be readily mounted to the horn 26 by causing the mounting base 126u with the cutting blade 331 secured thereto to stick fast to the mounting groove 126m formed in the second end surface of the horn 26. In a case where the cutting blade 331 secured to the mounting base 126u made to stick fast to the horn 26 is deteriorated by wear or the like, the worn cutting blade 331 can be readily replaced by causing a new mounting base 126u together with a new cutting blade 331 to stick fast to the mounting groove 126m.

Alternatively, the mounting groove 126m in the second end surface of the horn 26 may be omitted and the mounting base 126u may be made to stick fast directly to the second end surface of the horn 26. The other components are the same as those of the above-described ninth embodiment and hence are represented by identical reference numerals, the description of which is dispensed with.

### (Sixth Exemplary Modification of Resonator)

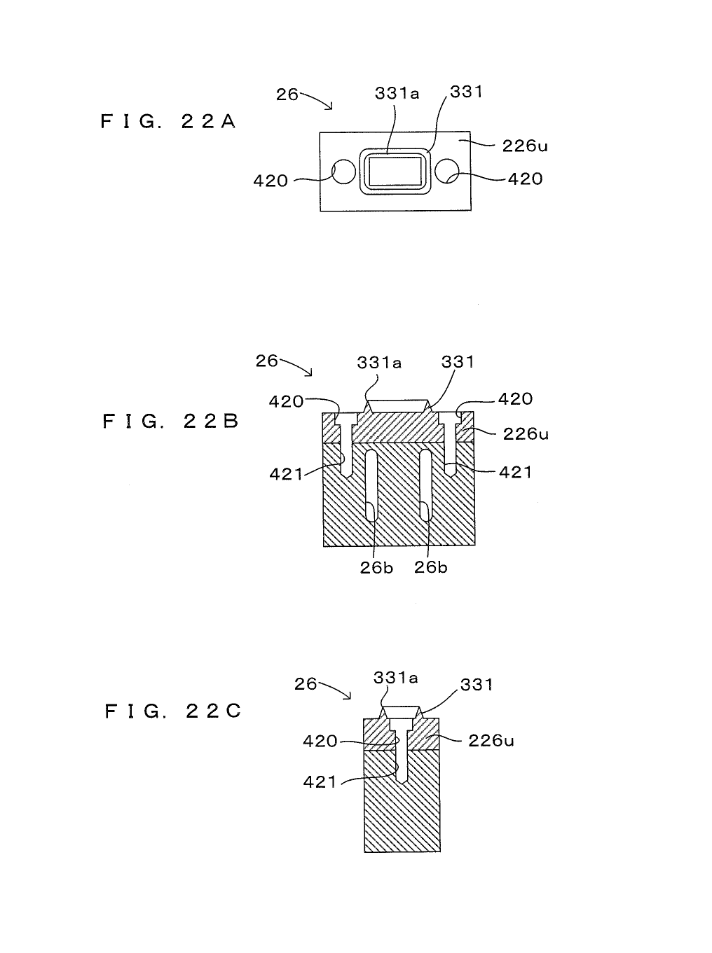

FIG. 22 is a group of diagrams showing a sixth exemplary modification of the horn 26 of the ninth embodiment. FIG. 22A is a bottom plan view of the horn 26. FIG. 22B is a sectional, view of the horn 26 in an upside-down position as seen from the front. FIG. 22C is a sectional side view of the horn 26 in the upside-down position. In the sixth exemplary modification, the cutting blade 331 is secured to the flat-plate mounting base 226u larger than the above-described mounting base 126u. The mounting base 226u is formed with bolt through-holes 420 on opposite sides of the cutting blade 331. The horn 26 has female threads 421 formed in the second end surface thereof at places opposed to the bolt through-holes 420.

Bolts (not shown) are inserted in and threadably engaged with the bolt through-holes 420 and the female threads 421. Thus, the mounting base 226u is fixed to the second end surface of the horn 26 whereby the cutting blade 331 is mounted to the horn 26. Such a structure provides for the case where the cutting blade 331 secured to the mounting base 226u mounted to the horn 26 is deteriorated by wear or the like. The worn cutting blade 331 can be readily replaced by fixing a new mounting base 226u together with a new cutting blade 331 to the horn 26 with the bolts. The other components are the same as those of the above-described ninth embodiment and hence are represented by identical reference numerals, the description of which is dispensed with.

### (Seventh Exemplary Modification of Resonator)

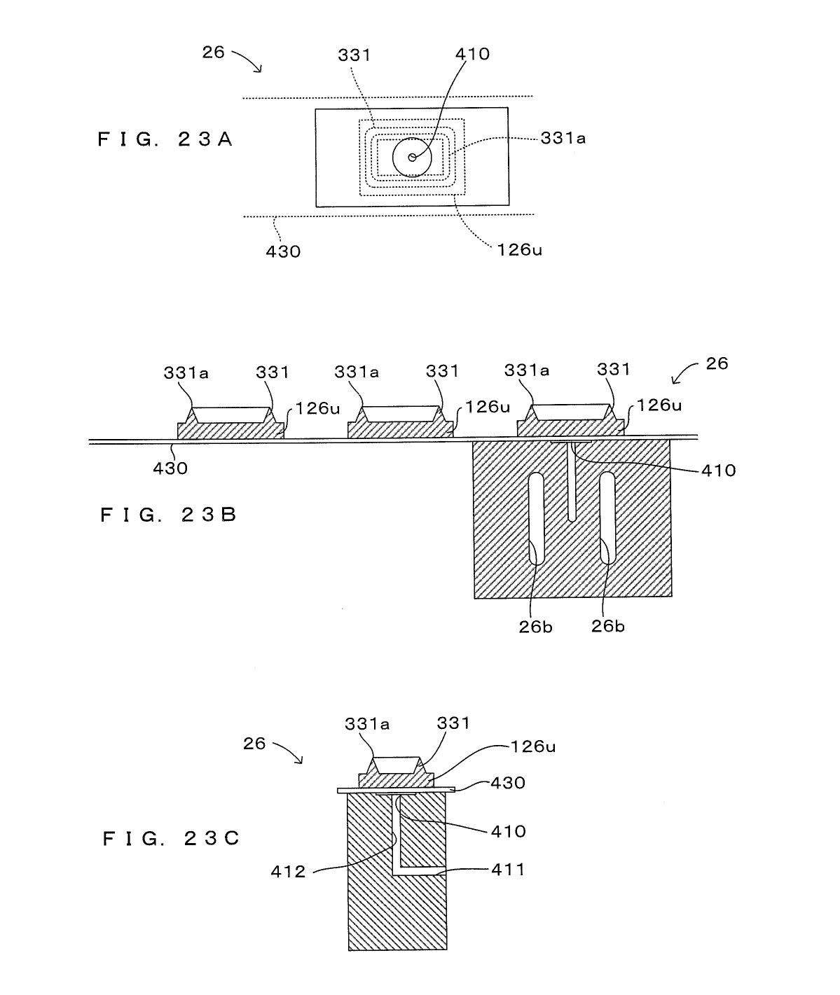

FIG. 23 is a group of diagrams showing a seventh exemplary modification of the horn 26 of the ninth embodiment. FIG. 23A is a bottom plan view of the horn 26. FIG. 23B is a sectional view of the horn 26 in an upside-down position as seen from the front. FIG. 23C is a sectional side view of the horn 26 in the upside-down position.

In the seventh exemplary modification, the horn 26 is formed with the suction hole 412 that communicates the suction orifice 410 formed in the second end surface of the horn 26 with the suction orifice 411 formed in the lateral side of the horn 26. A plurality of mounting bases 126u with the respective cutting blades 331 secured thereto are retained on a sheet-like retainer member 430 formed of a PET film or the like. The unit lustrated suction means sucks air from the suction orifice ill whereby the reduced pressure is applied to a back side of the sheet-like retainer member 430, causing any one of the mounting bases 126u on the retainer member 430 to stick fast to the second end of the horn 26.

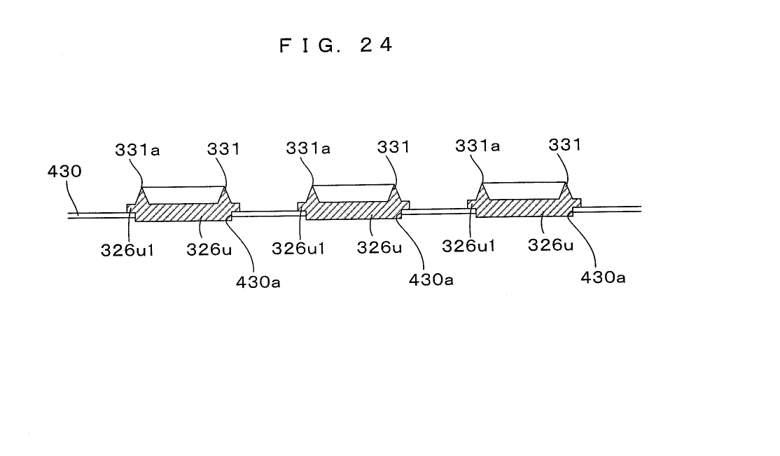

As shown in FIG. 24, a mounting base 326u may be formed with a flange 326u on an outer periphery thereof. The flange 326u1 engages with an outside circumference of a retaining hole 430a formed in the sheet-like retainer member 430 whereby the mounting base 326u is retained on the retainer member. FIG. 24 illustrates another exemplary method of retaining the mounting base according to the seventh exemplary modification, of the resonator.

Such a structure permits the cutting blade 331 to be readily mounted to the horn 26 by causing any one of the mounting bases 126u, 326u carried on the sheet-like retainer member 430 to stick fast to the second end of the horn 26. In a case where the cutting blade 331 on the mounting base 126u, 326u made to stick fast to the horn 26 is damaged or deteriorated due to wear or the like, the cutting blade 331 mounted to the horn 26 can be readily replaced by causing another mounting base 126u, 326u together with a new cutting blade 331 to stick fast to the second end of the horn 26. The other components are the same as those of the above-described ninth embodiment and thence are represented by identical reference numerals, the description of which is dispensed with.

### Tenth Embodiment

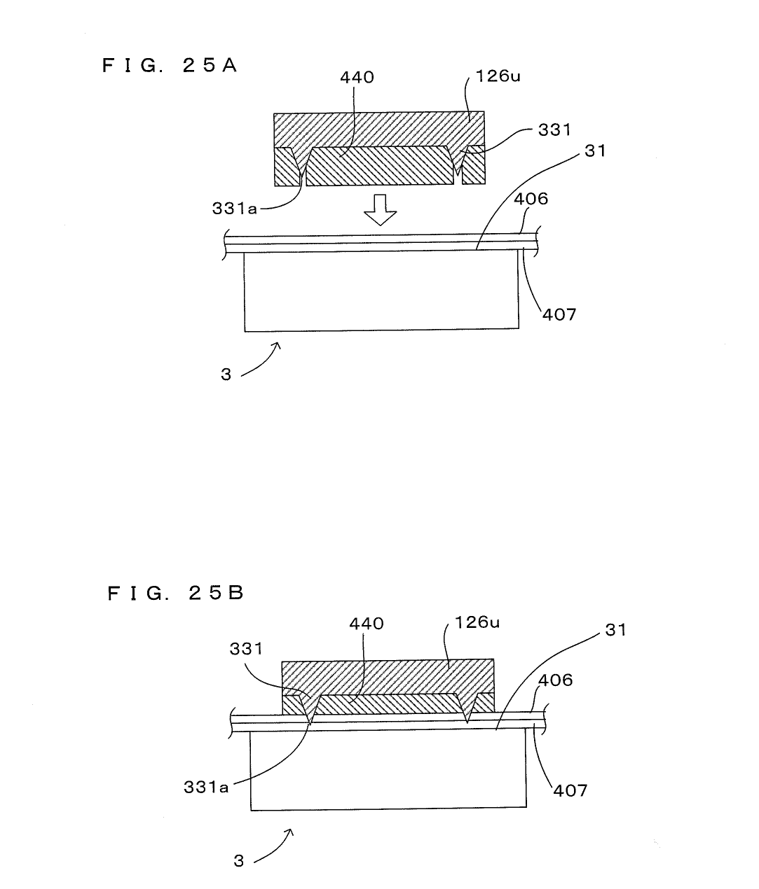

A tenth embodiment of the vibration cutting apparatus of the invention is described with reference to FIG. 25. FIG. 25 is a group of enlarged views showing an essential part of the tenth embodiment of the vibration cutting apparatus 1 of the invention. FIG. 25A is a diagram showing a cutting object placed under the cutting blade 331. FIG. 25B is a diagram showing a cut state of the cutting object. As shown in FIG. 25, this embodiment differs from the above-described ninth embodiment in that a pressure member 440 formed of an elastic member such as sponge or spring is provided on the mounting surface of the mounting base 126u, to which mounting surface the cutting blade 331 is secured. The other components and the operations thereof are the same as those of the above-described ninth embodiment, In the following description, therefore, identical or like reference numerals refer to the corresponding components of the above-described ninth embodiment and the description on the structures and operations thereof is dispensed with.

In this embodiment, a cutting object such as a sheet-like member which includes a PET film 407 having a copper foil 406 attached thereto is cut by the cutting blade 331. As shown in FIG. 25A, when the drive mechanism 4 lowers the cutting blade 331 with the copper foil 406 (the PET film 407) placed on the top surface 31 of the stage 3 disposed under the cutting blade 331, the pressure member 440 first comes into contact with the copper foil 406. If the cutting blade 331 is further lowered against the elastic force of the pressure member 440, as shown in FIG. 25B, the pressure member 440 is compressed while the cutting edge 331a of the cutting blade 331 projects from the pressure member 440 to cut the copper foil 406.

After the copper foil 406 is cut, the cutting blade 331 is moved up by the drive mechanism 4. At this time, the cutting blade 331 is moved up with the pressure member 440 pressing the copper foil 406 toward the stage 3. This ensures that a piece of copper foil 406 cut into a shape conforming to the predetermined outline of the cutting edge 331a of the cutting blade 331 is left on the stage 3, The pressure member can prevent the resultant copper foil cutout. 406 from fitting inside the cutting blade 331.

When cutting the copper foil 406, the cutting edge 331a of the cutting blade 331 is protected by cutting into the PET film 407. This negates the need for providing the top surface of the stage 3 with a protecting member for the cutting edge 331a, such as the buffer material.

### Eleventh Embodiment

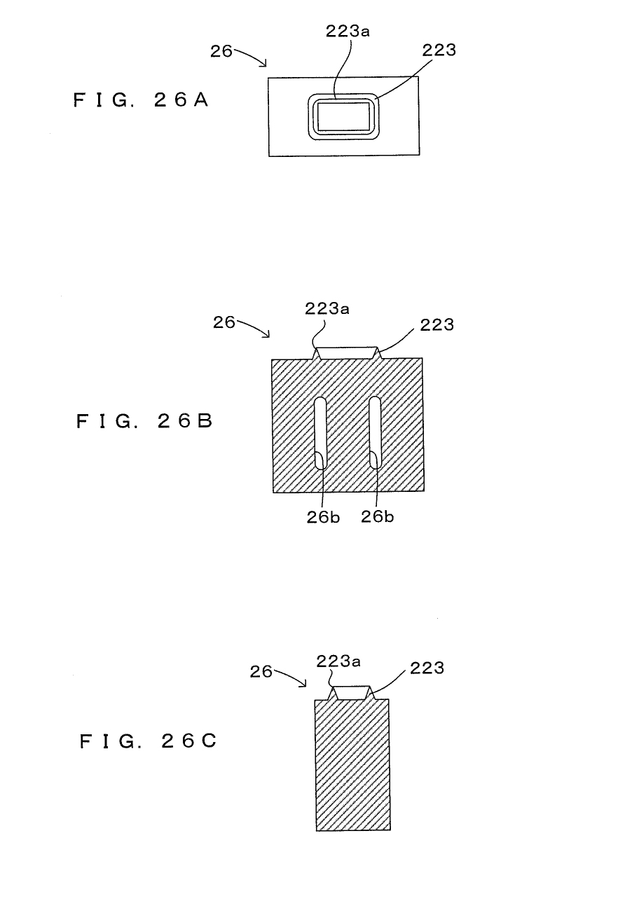

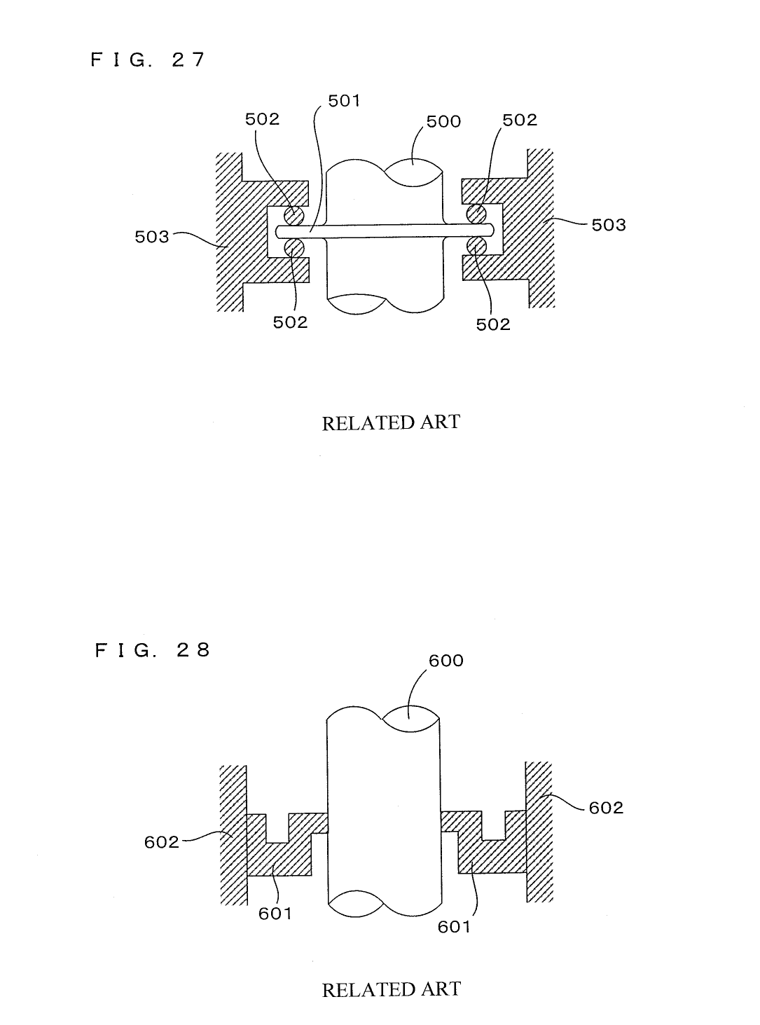

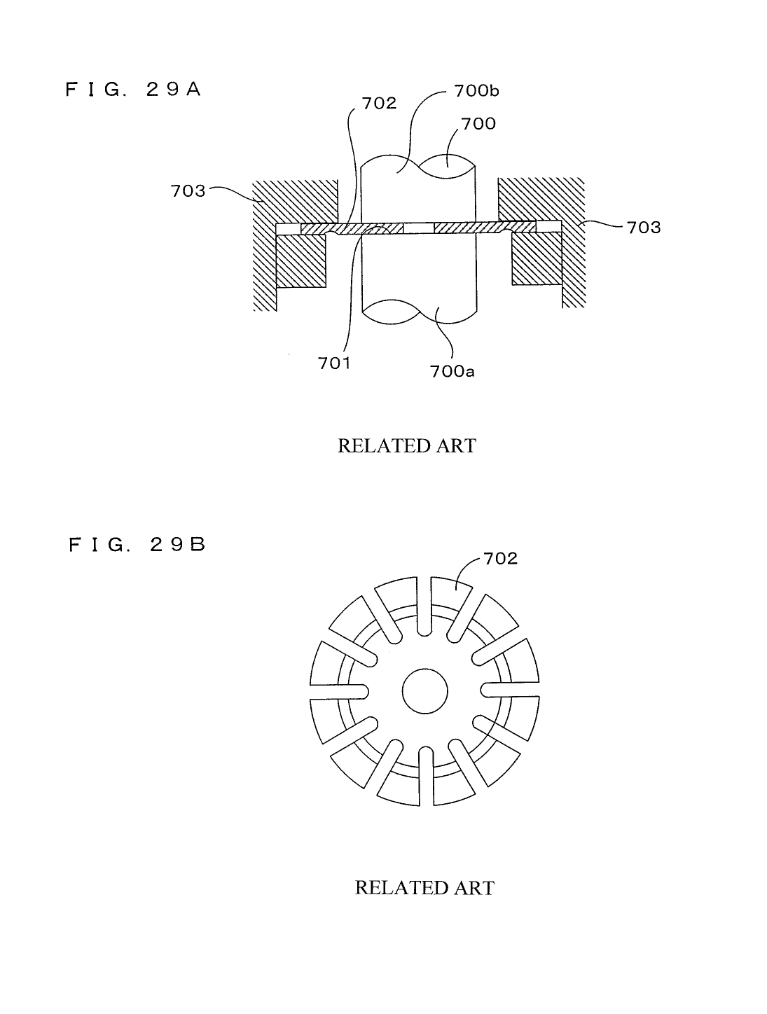

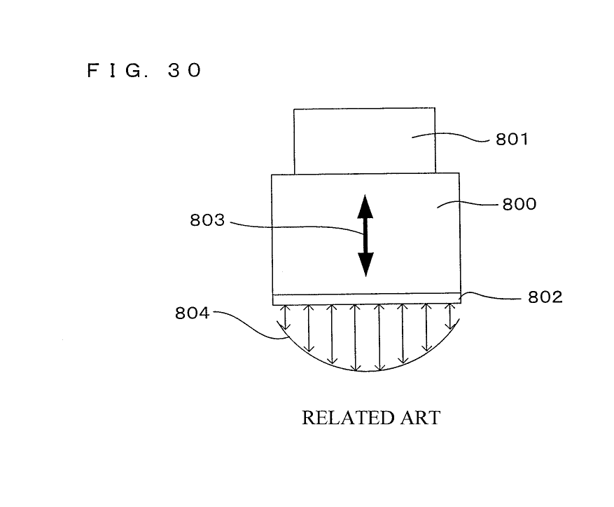

An eleventh embodiment of the vibration cutting apparatus of the invention is described with reference to FIG. 26. FIG. 26 is a group of diagrams showing a resonator according to the eleventh embodiment of the vibration cutting apparatus 1 of the invention. FIG. 26A is a bottom plan view of the resonator. FIG. 26B is a sectional view of the horn 26 in an upside-down position as seen from the front. FIG. 26C is a sectional side view of the horn 26 in the upside-down position. As shown in FIG. 26, this embodiment differs from the above-described ninth embodiment in that a cutting blade 223 with a cutting edge 223a is mounted to the mounting portion of the second end of the horn 26 by integrally forming the horn 26 with the cutting blade 223. The other components and the operations thereof are the same as in the above-described ninth embodiment. In the following description, therefore, identical and like reference numerals refer to the corresponding components of the ninth embodiment and the description on the structures and operations thereof is dispensed with.

It is to be noted that the present invention is not limited to the above-described embodiments and various modifications other than the above may be made thereto within the spirit and scope of the invention. Although the horn is formed with two elongated holes in the foregoing embodiments, for example, the resonator need be formed with at least one elongated hole. The size, number, direction and the like of the elongated hole may be adjusted as needed according to the configuration of the resonator such that the vibrations may be properly applied, to the cutting blade 23, 123.

While the ultrasonic vibration is applied to the cutting blade 23 in the above-described embodiments, the vibration to be applied to the cutting blade 23, 231 is not limited to the ultrasonic vibration. For example, low-frequency vibration or a superimposed vibration of vibration having a low frequency of about 100 Hz and ultrasonic vibration may also be applied to the cutting blade 23, 231. The application of the low-frequency vibration makes the cutting blade 23, 231 less susceptible to adhesion of cut debris from the object and the like.

The resonator may be supported by the support means at three or more points. It is preferred that at least the portion of the clamp means (the grasping portion) that makes contact with the grip portion is formed of the above-described material. The configuration, material, dimensions and the like of the resonator are not limited to the above-described examples and are optional.

While the drive mechanism 4 of the above-described embodiments is designed to move the resonator by means of the driving motor 41, the resonator may also be moved by means of an actuator operated by fluid pressure of an air cylinder, a linear motor or the like.

In the above-described embodiments, the flat-plate cutting blade 23 (the cutting blade 123) has the recessed grooves 23b formed in the opposite lateral sides of the second end opposite to the first end which is formed with the cutting edge 23a (the cutting edge 123a). The recessed groove 23b extends across the width of the cutting blade. Alternatively, the mating groove formed at the second end of the horn may be formed with recessed grooves in opposite inside surfaces thereof. Thus, the cutting blade 23 (the cutting blade 123) may be mounted, to the horn by fittably inserting the second end of the cutting blade 23 (the cutting blade 123) in the mating groove and bonding the side surfaces of the second end of the cutting blade 23 (the cutting blade 123) to the mating groove across the width thereof. Otherwise, the recessed grooves may also be formed in the opposite side surfaces of the second end of the cutting blade and in the opposite inside surfaces of the mating groove formed at the second end of the horn.

Although an illustration is omitted, a structure may be made such that rotary retaining means shaped like a short column is rotatably retained on the second end of the horn and a ring-like cutting blade is mounted to a periphery of the rotary retaining means. Such a structure permits the object to be cut into a desired configuration by rotating the cutting blade while applying the ultrasonic vibrations to the cutting blade.

In the above-described ninth to eleventh embodiments, the resonator need not necessarily be formed with the elongated hole in a case where the cutting blade having the cutting edge of the predetermined outline, is mounted to the second end of the resonator, and where the cutting blade has sufficiently small widthwise and depthwise dimensions (a sufficiently small area as seen in plan) as compared with an area of the second end of the resonator that the amplitude of the vibrations applied to the cutting blade is not significantly varied in the whole body of the cutting blade.

### INDUSTRIAL APPLICABILITY

The present invention earn he applied to a wide range of techniques for cutting the object with the cutting blade by applying the vibrations to the cutting blade.

### Reference Signs List

1: VIBRATION CUTTING APPARATUS

3: STAGE

4: DRIVE MECHANISM (MOVING MEANS)

6: CONTROLLER (CONTROL MEANS)

21, 121, 221, 321, 421: RESONATOR

22: OSCILLATOR

23, 123, 223, 231, 331: CUTTING BLADE

23a, 123a, 223a, 231a, 331a: CUTTING EDGE

23a1: POINTED TIP

23b: RECESSED GROOVE

24: SUPPORT MEANS

25a, 126c, 226c: GRIP PORTION

26a: MATING GROOVE

26b, 126b, 226b, 326b: ELONGATED HOLE

26m, 26p: STEP PORTION

26n, 26q: MOUNTING SURFACE

26u, 126u, 226u, 326u: MOUNTING BASE

28: CLAMP MEANS (GRASPING PORTION)

31, 31a: TOP SURFACE

31b: NOTCH

32: COPYING MECHANISM

430: RETAINER MEMBER (SHEET-LIKE MEMBER)

1-14. (canceled)

15. A vibration cutting apparatus for cutting an object with a cutting blade by applying vibrations to the cutting blade, comprising:
a resonator connected to an oscillator at a first end thereof and mounted with the cutting blade at a mounting portion defined by a second end thereof opposite to the oscillator; and
support means that includes a grasping portion for grasping a grip portion of the resonator by directly clamping and fastening the grip portion and that comprises an inelastic member for supporting the resonator.

16. The vibration cutting apparatus according to claim 15, further comprising:
a stage including a top surface on which the object is placed;
moving means for moving the resonator toward or away from the stage, the resonator being supported by the support means in a manner to direct a cutting edge of the cutting blade toward the stage; and
control means for controlling the moving means,
wherein the control means operates the moving means to move the resonator to the stage in a manner to allow the cutting blade to apply a constant pressure force of a predetermined value to the object, and the predetermined value is defined to restrict a degree of edge bending of the cutting blade caused by cutting the object to within allowance limits of cutting precision required of cutting the object.

17. The vibration cutting apparatus according to claim 16, wherein the stage includes a copying mechanism for adjusting the inclination of the top surface, and
wherein the control means operates the moving means to bring the cutting edge into contact against the top surface by moving the resonator to the stage, and allows the copying mechanism to be moved with moment generated by pressing the cutting edge against the top surface thereby adjusting the inclination of the top surface and establishing agreement between the inclination of the cutting edge and that of the top surface.

18. The vibration cutting apparatus according to claim 16 or 17, wherein the stage is provided with a buffer layer including the top surface, and
wherein the buffer layer is formed of a material that permits the cutting blade to cut into the buffer layer.

19. The vibration cutting apparatus according to any one of claims 15 to 17, wherein the mounting portion includes a flat-plate mounting base, a first side of which is mounted with the cutting blade and a second side of which is secured to the second end of the resonator, and
wherein a plurality of the mounting bases are carried on a sheet-like member and any one of the mounting bases on the sheet-like member is made to stick fast to the second end of the resonator.

20. The vibration cutting apparatus according to any one of claims 15 to 17, wherein the resonator has at least one elongated hole cut through a lateral side thereof.

21. The vibration cutting apparatus according to claim 20, wherein the resonator has two or more elongated holes cut through the lateral side thereof, and
wherein the individual elongated holes are uniformly inclined relative to a vibration direction of the oscillator.
